(19) United States
(12) Patent Application Publication
(10) Pub. No.: US 2015/0039295 A1
(43) Pub. Date: Feb. 5, 2015

(54) NATURAL LANGUAGE PROCESSOR

(71) Applicant: Alona Soschen, West, Ottawa (CA)

(72) Inventor: Alona Soschen, West, Ottawa (CA)

(21) Appl. No.: 14/367,490

(22) PCT Filed: Dec. 20, 2012
(86) PCT No.: PCT/CA2012/001176

§ 371 Date: Jun. 20, 2014

Related U.S. Application Data
(60) Provisional application No. 61/577,762, filed on Dec. 20, 2011.
(60) Provisional application No. 61/607,674, filed on Mar. 7, 2012.
(60) Provisional application No. 61/642,131, filed on May 3, 2012.
(60) Provisional application No. 61/642,512, filed on May 4, 2012.
(60) Provisional application No. 61/642,525, filed on May 4, 2012.
(60) Provisional application No. 61/663,195, filed on Jun. 22, 2012.

(51) Int. Cl. G06F 17/28; G06F 17/27

(52) U.S. Cl. CPC G06F 17/28; G06F 17/2705
USPC 704/9

(57) ABSTRACT

Disclosed is a method for converting a plurality of words or sign language gestures into one or more sentences. The method involves the steps of: obtaining a plurality of words; assigning a part of speech tag to each of said words; assigning a sentence structure tag to said plurality of words; and parsing said words into one or more sentences based on a predefined sentence structure. The method can be implemented by a computer to provide a translator that more accurately reflects the natural language of the original text.

### FIELD OF THE INVENTION

The present invention generally describes a method for processing language. More specifically, the method involves natural language processing for the analysis of texts or sign language gestures independently of the language they are written in (multi-lingua), their disambiguation, and summarization.

### BACKGROUND OF THE INVENTION

The growth of information in the digital age has created a significant burden vis-à-vis categorizing this information and translating useful information from one language to another. For example, large volumes of texts need to be processed in a variety of business applications, as well as for the internet search performed on the unstructured domains such as emails, chat rooms, etc. The search in its turn requires text analysis, text summarization, and often times translation to languages other than the source language. So far, the existing parsers can only handle a limited set of language processing functions.

The existing Natural Language Processing (NLP) tools utilize ‘word-by-word’ technique of text analysis, which has led to a number of problems. For example, this technique accounts for the easiness of disruptive interventions and redirection in search engines as a result of keyword-based spamming attacks. Another serious problem is that parsing processes are considerably slowed down because there is no efficient analytical syntax-semantic interface device. The interpretative (semantic) and the structural (syntactic) parts of the language are treated as two autonomous objects, each with a set of its own unresolved issues.

Previous syntactic analyses within the Chomskyan framework have taken a propositional (eventive) structure of a sentence as the starting point, thus building syntactic trees in a particular manner (the X-bar X′ model of the syntactic tree). Chomsky's theory was designed for English, a language with Subject-Verb-Object (SVO) order, while the majority of the human languages have Subject-Object-Verb (SOV) and Verb-Subject-Object (VSO) order. Grammatical linguistic expression is the optimal solution, the reason why a particular word order ‘Subject-first’ is preferred across languages. This consistency regarding the order of major constituents (Subject-Object) reflects the ways the system implements the notion ‘preference’, which attests to the intrinsic hierarchy of arguments: the Subject-Object (SO) order remains constant in 96% of languages. The SOV order (rather than SVO) is the predominant one.

Chomsky's model formed the basis for verb-centered syntactic representations. An extra bar-level was crucial for combining three lexical elements in a configuration [XP [XP₁ X [X′ XP₂]]] such as [VP [NP₁ V [V′ NP₂]]] because Chomsky's theory disallows combinations of other than two elements at a time. The bar-level X′ solves the problem of combining three elements: a Nominal Phrase (NP₁), a Nominal Phrase (NP₂), and a verb (V). NP₁ is a specifier of V and NP₂ is its complement, the obligatory elements in a sentence of the kind [Mary (NP₁) [likes (V) John (NP₂)]]. In his later work, Chomsky disposed of the bar-level, and put forward a new theory of Merge, the key syntactic operation that combines any two elements at a time, while each newly formed element is a sum of the two that precede it. The problem with the application to syntactic analyses of both the X-bar and Merge models is that it results in a rigid sentence structure that strictly depends on the sub-categorization frame of a particular verb. However, the same verb can have a different number of arguments associated with it. In sentences of the type: ‘People like to read (books)’, the same verb ‘read’ may subcategorize either for one argument ‘people’ or for two arguments ‘people’ and ‘books’. Another example is a sentence, such as, ‘The pony jumped over the bench slipped’ that cannot be processed because ‘The pony jumped over the bench’ is treated as a completed sentence, and the processing stops there. The analyses based on the verbal sub-categorization frames of fail in such and similar lexical environments, which are abundant in natural languages.

The existing processing tools utilized for the purposes of semantic analyses encounter several problems because phenomenon, such as conceptual categorization is not well understood. It is not clear what information is used and what kind of computation takes place when constructing categories.

There is a need for more dynamic and powerful language processing tools to be developed in order to provide more efficient means to process text.

### SUMMARY OF THE INVENTION

It is an object to provide a method that addresses at least some of the limitations of the prior art. According to an aspect of the present invention, there is provided a method for converting a plurality of words into one or more sentences. The method comprises the steps of: obtaining a plurality of words; assigning a part of speech tag to each of said words; assigning a sentence structure tag to said plurality of words; and parsing said words into one or more sentences based on a predefined sentence structure.

In one embodiment, the part of speech tag is selected from noun, verb, adverb, adjective, conjunction and preposition. In another embodiment, the sentence structure tag is selected from subject verb, subject verb object, subject verb object object, subject object verb, verb subject object, object subject verb, verb subject object and object verb subject.

In a further embodiment, the method comprises applying a set of rules to boundary absent word strings prior to parsing said words into one or more sentences.

In yet a further embodiment, the method further comprises applying a set of rules to said one or more sentences to confirm conformity with syntactic and semantic parameters.

In another embodiment, the method further comprises identifying relevant argument configurations based on the part of speech tagged words prior to assigning sentence structure tags to the plurality of words. The argument configurations can be entity relation, entity relation entity and entity relation entity (relation) entity. The argument configurations also generate strings of words that are compared against the sentence structure tags to identify legitimate and illegitimate strings of words.

In another embodiment, the step of identifying relevant argument configurations comprises assigning an embedded clause tag to the words.

According to another aspect of the present invention, there is provided a computer implemented method for converting a plurality of words into one or more sentences, comprising the steps of: obtaining a plurality of words; assigning a part of speech tag to each of said words; assigning a sentence structure tag to said plurality of words; and parsing said words into one or more sentences based on a predefined sentence structure.

According to a further aspect of the present invention, there is provided a computer program product comprising a computer readable memory storing computer executable instructions thereon that when executed by a computer perform the method steps identified above.

### BRIEF DESCRIPTION OF THE DRAWINGS

These and other features, aspects and advantages of the present invention will become better understood with regard to the following description and accompanying drawings wherein:

FIG. 1 is an illustration of mental representations for language as a biological sub-system;

FIG. 2 is a generalized representation of the mental process for concept formation;

FIG. 3 is an illustration of a generalized representation of the concept ‘tree’;

FIG. 4 is a generalized representation of the inter-conceptual links, or relations between entities;

FIG. 5 is a generalized representation of dynamic and static parts of the mental processing domain;

FIG. 6 is a generalized representation of concept formation and expansion;

FIG. 7 is a flowchart representing the generalized application of the method for natural language processing according to an embodiment of the invention;

FIG. 8 is a flowchart representing the processing of lexical strings to identify argument configurations according to an embodiment of the invention;

FIG. 9 is a flowchart representing implementation of processing lexical strings in Simple Sentences according to an embodiment of the invention;

FIG. 10 is a flowchart representing the processing of Complex Sentences according to an embodiment of the invention;

FIG. 11 is a flowchart representing the processing of lexical strings in simple sentences to fill the gaps according to an embodiment of the invention;

FIG. 12 is a flowchart representing the processing of simple texts to produce a summary according to an embodiment of the invention;

FIG. 13 is a flowchart representing the syntax/semantics interface for text processing and disambiguation according to an embodiment of the invention;

FIG. 14 is a flowchart representing a graph of 3-Tier architecture according to an embodiment of the invention; and

FIG. 15 is a graphical representation of a basic computer system that incorporates the method of the invention.

### DETAILED DESCRIPTION OF THE INVENTION

The following description is of a preferred embodiment by way of example only and without limitation to the combination of features necessary for carrying the invention into effect.

The invention is directed to a novel method of Natural Language Processing (NLP), namely a cognitively based interface syntactic and semantic parsing, for the analysis of texts or sign language gestures, their disambiguation, and summarization. Optionally, the method can be adapted to provide a gap filling (word prediction) function, as well as a targeted search within the text. The syntactic parser receives a string of words absent sentence/clause boundaries, and performs a step-by-step analytical procedure starting with the first word in the input string. The analysis consists of operations based on predetermined rules on syntactic units and semantic primitives in semantic webs. At the initial stage, the parser identifies arguments and establishes dependencies between them following a set of predetermined rules. The syntactic parser assigns syntactic roles to arguments and identifies sentence and clause boundaries. The semantic parser receives the processed input strings and performs their semantic analysis. At the final stage, completed text analysis and disambiguation are achieved, and a summary of the text is produced and, if applicable, gap filling is performed and a targeted search within a limited domain is performed.

The invention includes a dictionary look-up where lexical items are identified according to Parts of Speech (POS), the advanced tagging systems for POS and Sentence Structure (SST), and a semantic web for a limited unstructured domain. For the purposes of this disclosure, lexical or lexicon refers to both written text and images, or gestures, representing language.

The method is based on what is referred to herein as an Argument-Centered Model (ACM), which approximates the human cognitive mechanism for language acquisition and uses as a combined result of theoretical linguistics, bio- and neuronal linguistics, computational modeling, and language acquisition studies. The rules are derived from the general biological principles that determine attainable languages. This makes it broadly applicable to any language. The cross-linguistic language processor uses extensive data from several major language groups: Germanic, Romance, Slavic, Semitic, Congo, and Sino-Tibetan. The syntax-semantics interface device of ACM accomplishes simultaneous grammatical and lexical analyses by means of a set of predetermined rules for computational procedures. A recursive syntactic operation derives an infinite number of sentences. A finite set of principles determines the interpretative (semantic) part of language. The model recapitulates the stages of grammar acquisition and concept formation starting with an early stage from childhood to adulthood.

There is also a need for technology that can efficiently interpret American Sign Language and translate between sign language (ASL) and spoken or written language (S/WL). The technology described herein incorporates useful applications for devices of auto-interpretation of sign language, teaching sign language, and even communication with computers using sign language. Sign language needs to be processed in a variety of applications to improve communication between ASL speakers and others. The technology described herein allows for ASL analysis and disambiguation, as well as S/WL analysis and disambiguation.

The current invention offers a method and apparatus for processing the input text, by implementing a cognitively based model within a framework that involves atomic processing units. The syntactic structure of a sentence is given by a recursive rule, as this provides the means to derive an infinite number of sentences using finite means. For the same reason, a finite set of principles is used to determine the rules for the interpretive (semantic) part of language.

The method recapitulates mental computation of syntax as closely related to the inter-conceptual connections between the entities in a semantic space. The syntax-semantics interface of the method is designed to accomplish simultaneous grammatical and lexical analyses by means of a set of predetermined rules for computational procedures.

The method relies on a particular set of operations that are not directly related to binding arbitrary arguments to the thematic roles of verbs but rather establish a hierarchy of arguments (entities). The solution that satisfies the massiveness of the binding problem exhibits the ability to bind arbitrary arguments to the thematic roles of arbitrary verbs in agreement with the structural relations expressed in the sentence.

The basic property of syntax is a syntactic operation that combines lexical items into units in a particular way. This operation is characterized by limitations imposed on (1) thematic domains—such as a fixed number of arguments in. e.g. ‘Mary smiles’ (1 argument), ‘Mary kisses John’ (2 arguments), and ‘Mary gives John an apple’ (3 arguments); and (2) derivational phases. Derivational phases are a unique recursive mechanism designed for the continuation of movement, i.e. restructuring of elements that enter into linguistic computation. As an example, ‘John is kissed by Mary’ is derived from ‘Mary kisses John’ (a phase) which results in a passive sentence ‘John is kissed t_{John} by Mary’ where t_{John} is a trace of a noun placed in the sentence initial position. ‘Mary John kisses t_{John}’ is illicit because an because ‘kisses John’ is not a phase and the element cannot be moved to a position that is not at the edge of a phase. Consequently, restructuring is not possible.

The conditions that account for the essential properties of syntactic formants (trees) are identified and incorporated in the present method. In the current model, the syntactic processing starts from recursive definitions and application of optimization principles, and gradually develops a formal method that generates a mode which connects arguments and expresses relations between them.

The reiterative operation assigns primary role to non-verbal entities based on the non-propositionality of the basic syntactic configurations.

The model and apparatus implements formal (first-order, conjunctivist) logic in a revised structure of semantic representations where argument-centered concepts are defined based on the primary function of the object in respect to the agent. Not wishing to be bound by theory, adults and children categorize differently—young children form a joint category for a car and a driver, while adults group kinds of cars and professions separately. Similarly, in the present implementation, objects are grouped according to their primary function with respect to the participant. A particular property is identified or selected to serve as the core of a specific conceptual domain. This implementation of the method efficiently handles semantic analyses for translation and summarization of a variety of texts, gradually building up conceptual domains in a way that parallels the stages of human concept formation from childhood to adulthood.

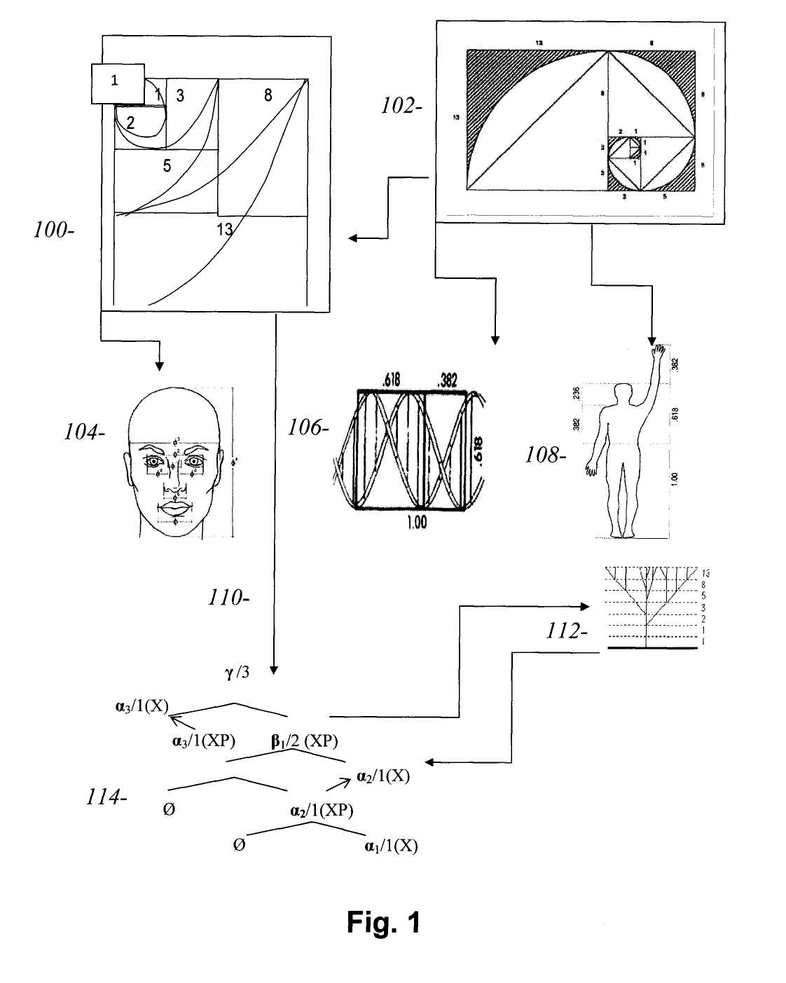

FIG. 1 is an illustration of mental representations of natural language as a biological sub-system of efficient growth. The linguistic structures have the properties of other biological systems, which determine the underlying principles of the computational system of the human language. By including these objective principles of architecture, the present method restricts outcomes determining attainable languages, which makes it broadly applicable to any language. A physical law (Natural Law, N-Law) exemplified as the Fibonacci series (FS) where each new term is the sum of the two that precede it is attested in language, just as in other mental representations. FS is one of the most interesting mathematical curiosities evident in every living organism. They appear, for example, in the arrangement of branches of trees, leaves and petals, and spiral shapes of seashells 102. The number of ‘growing points’ corresponds to FS: X(n)=X(n−1)+X(n−2): {0, 1, 1, 2, 3, 5, 8, 13, . . . with the limit ratio (Golden Ratio GR) between the terms 0.618034 . . . , Such a system follows from simple dynamics that impose constraints on the arrangement of elements to satisfy conditions on optimal space filling. Successive elements of a certain kind form at equally spaced intervals of time on the edge of a small circle, representing the apex. These elements repel each other (similar to electric charges) and migrate radially at some specified initial velocity. As a result, the radial motion continues and each new element appears as far as possible from its immediate successors. This arrangement related to maximizing space is important e.g. for closely-packed leaves, branches, and petals, because it ensures a maximal exposure to the sun and optimal space filling.

In humans, GR appears in the geometry of DNA 106 and physiology of the head 104 and body 108. On a cellular level, the ‘13’ (5+8) Fib-number present in the structure of cytoskeletons and conveyer belts inside the cells is useful in signal transmission and processing. The brain and nervous systems have the same type of cellular building units; the response curve of the central nervous system also has GR at its base. This supports the theory underlying the current invention: N-Law applies to the universal principles that govern general mental representations evident in every natural language.

The biological systems of efficient growth share certain remarkable properties with the linguistic system: both of them are characterized by discreteness and economy. The N-Law application to language analysis accurately defines the properties of syntactic trees, such as limitations imposed on the number of arguments, and the principles of sentence formation. The revised tree structure is maximized in such a way that it results in a sequence of categories that corresponds to Fib-patterns 112. The revised syntactic tree has a fixed number of nodes in thematic domains 114. The N-Law accounts for the limitations imposed on the number of arguments (1, 2, 3) 110.

In the present method, the essential attributes of language derived from general physical principles incorporate the species-specific mechanism of infinity that makes natural language apparatus crucially different from other discrete systems found in nature. There is no limit to the length of a meaningful string of words. These properties are exemplified e.g. in a well-known nursery rhyme ‘The House That Jack Built’. In the rhyme, each sentence Xₖ with a number of words n is succeeded by a sentence Xₖ₊₁ with a number of words n+m: Xₖ₊₁ (n)=Xₖ (n+m), X₂ (n)=X₁ (n+4), . . . , X₅ (n)=X₄ (n+4), X₆ (n)=X₅ (n+8), . . . . In contrast, other biological systems exhibit finiteness. Language is discrete: there are no half-word sentences. Syntactic units can also be seen as continuous: once a constituent is formed, it cannot be broken up into separate elements. As an example, ‘The dog chased the cat’ is the basic representation; in a passive construction ‘The cat was chased t_{—the cat} by the dog’ the sentence undergoes restructuring and Noun Phrase ‘the cat’ that consists of Determiner ‘the’ and Noun ‘cat’ is placed at the beginning of the sentence as a constituent. Otherwise ‘Cat was chased the _{cat} by the dog’ is not grammatical correct: the constituent NP is broken up into parts. The preservation of already formed constituents (Law of Preservation LP) is one of the key requirements of language apparatus. In contrast, segments comprising other N-Law-based systems of efficient growth can in principle be separated from one another.

The application of N-Law logic to the analysis of syntax results in the re-evaluation of syntactic tree as a part for a larger optimally designed mechanism where each constituent may appear either as a part of a larger unit or a sum of two elements, accordingly. For example, one line that passes through the squares ‘3’, ‘2’, and ‘1’ connects ‘3’ with its parts ‘2’ and ‘1’; the other line indicates that ‘3’ as a whole is a part of ‘5’. The pendulum-shaped graph representing constituent dependency in language apparatus 100 is contrasted with a non-linguistic representation where one line connects the preceding and the following elements in a spiral configuration of a sea-shell 102. The distance between the ‘points of growth’/segments of a sea shell can be measured according to GR, to satisfy the requirement of optimization. In the structure of syntactic representations, in contrast with other natural systems of growth, each element appears as either discrete (a sum of two elements) or continuous (a part of a larger language apparatus 100). The linguistic structures combine the properties of other biological systems with the species-specific properties that determine the computational system of the human language not found in other systems of efficient growth.

The N-Law logic requires each successive element to be combined with a sum of already merged elements, making singleton sets indispensable for recursion. New terms are created in the process of merging terms with sets to ensure continuation of thematic domains 114. The newly introduced operation zero-Merge (Ø-M) distinguishes between terms {1}/X and singleton sets {1, 0}/XP. The minimal building block that enters into linguistic computation is the product of O-M, the operation responsible for constructing elementary argument-centered representations that takes place prior to lexical selection, at the point where a distinction between terms {1}/X and singleton sets {1, 0}/XP is made. The LP induces type-shift, or type-lowering, from sets to entities at each level in the tree: α₂/1 is shifted from singleton set {α₁, 0} (XP) to entity α₂ (X) and merged with α₃ (XP). The type of α₃/1 is shifted from singleton set {α₂, 0} (XP) to entity α₃ (X) and merged with β₁ (XP). There is a limited array of possibilities for the Fib-like argument tree depending on the number of positions available to a term adjoining the tree. This operation either returns the same value as its input (Ø-Merge, α₁/1(X)), or the cycle results in a new element (N-Merge, α2/1(XP) in thematic domains 114. The recursively applied rule adjoins each new element to the one that has a higher ranking in a bottom-up manner, starting with the term that is ‘Ø-Merged first’. The N-Law logic applied to the analysis of syntactic trees provides an account for the argument-centered structure in Fib-patterns 112 that is built upon hierarchical relations. In the present method, the focus is shifted from verb to noun.

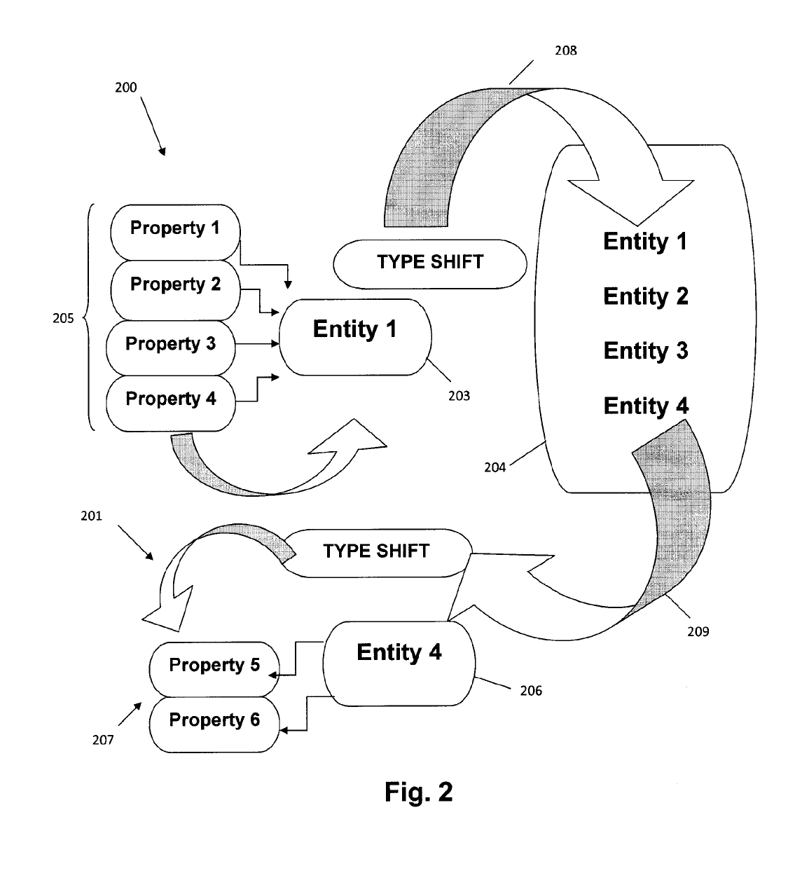

FIG. 2 is a generalized representation of the mental process for concept formation. Semantic rules in FIG. 2 are determined in compliance with the Law of Type-Shift (experiential recursion) for semantics as described herein. As mentioned herein, Experiential Recursion is a type-shifting mechanism from entities to properties and from properties to entities. The formal mechanism of a relationship between an object and a set of similar objects implies a flexible choice of any of the two levels (sets of objects, sets of properties).

The mechanism of minimal links between conceptual domains operates according to the rules on the sets representing two successive levels of cognitive specificity 200, 201. The sets require saturation by input on both levels. At one level, a relationship holds between an object 203 and a set of similar objects 204 where individuals come solely as representatives of homogeneous sets of characteristic features 205. At the next level, entities 206 are instantiated as sets of characteristic features 207. Semantic links 208, 209 are established between particular sets of characteristic features 205, 207 and their inputs.

As an example, lung diseases as a set of ‘objects’ (particular diseases) includes asthma, bronchitis, lung cancer, pneumonia, emphysema, and cystic fibrosis. Whereas, each disease is represented as a set of characteristic features (symptoms), such as difficulty breathing, wheezing, coughing, and shortness of breath for asthma. As long as new, previously unknown, symptoms are being discovered, semantic links are being established between a set of symptoms for a particular disease and the set's novel input (a newly discovered symptom). At one level, a relationship holds between an object (asthma) and a set of similar objects (lung diseases) as representatives of homogeneous sets. At the next level, asthma is instantiated as a set of characteristic features (i.e. the symptoms). Semantic links are established between characteristic features of diseases to ensure parsimonious evaluation and analysis of the patient's condition.

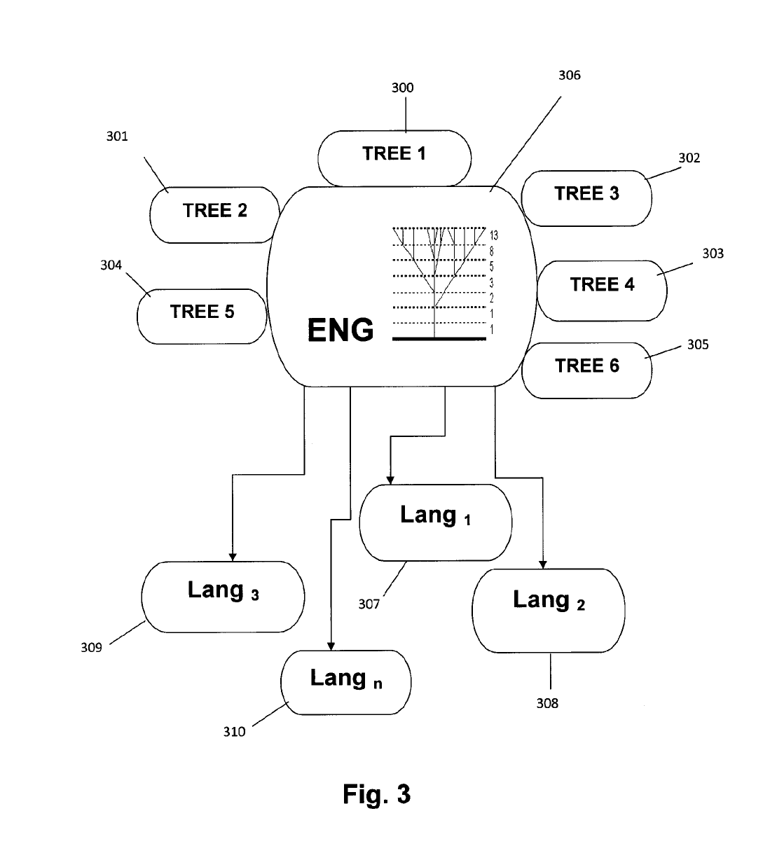

FIG. 3 is an example of a generalized conceptual representation ‘tree’. The process of conceptualization is dependent on the external experiential input that varies from individual to individual. Speakers of the same language may have the concept in question equated with ‘a palm tree’ (Tree 1)(300), ‘a birch tree’ (Tree 2)(301), ‘a maple tree’ (Tree 3)(302), etc (303-305). Further, the ‘adult’ definition of the concept ‘tree’ is subjective and is consistent with a specific ontology in question, e.g. ‘a woody perennial plant’, ‘representation of the abstract structure in syntax’. Yet further, linguistic representations of the above concept differ depending on a particular language of the individual: ‘arbol, ‘derevo’, ‘tree’ for Spanish (Lang 1)(307), Russian (Lang 2)(308), and English (Lang 3)(309), respectively. Further linguistic representations can be added (310).

Without the core representation of a concept it would be impossible for the individuals to reach a consensus in understanding the concept. The ontology of ‘a woody perennial plant’ comprises the core representation of the concept ‘tree’. In FIG. 3, the core ENG (306) is instantiated by processing relevant representations of mental structures and their components. The processing involves processing brain functions or neural activity data collected as a cognitive response to stimulus.

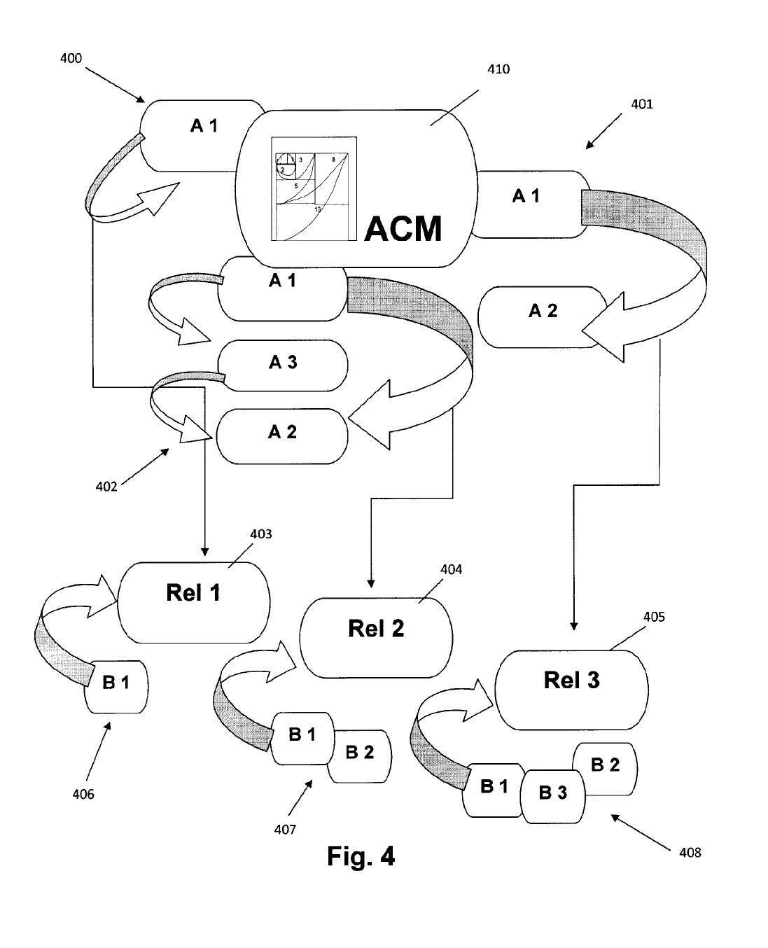

FIG. 4 is a generalized representation of the inter-conceptual links, or relations between entities, depending on a number of elements that enter semantic computation. The N-Law described above justifies the constraints on a number of elements in semantic clusters and the properties of arrangement of these elements in a specific way that assigns a linear order to lexical items in syntactic representations. Lexical elements/entities are combined in the method into clusters where each cluster is a hierarchical structure with the maximal number of 3 elements. Those clusters are then arranged according to the rules of a specific language e.g. word order subject-verb-object (SVO).

In FIG. 4, the current implementation identifies argument configurations (410) consisting of identification of three argument sets of {A 1}(400), {A 1, A 2}(401), {A 1, A 2, A 3}(402) and relation dependencies (between these arguments) as Rel 1 (403), Rel 2 (404), and Rel 3 (405). The implementation of this method classifies the entities in that they become part of the relation dependencies Rel as sets of {B 1}(406), {B 1, B 2}(407), and {B 1, B 2, B 3}(408). For example, in the following medical history, inter-conceptual relations are identified as {B 1, B 2}, {B1′, B 2′}, where B 1′ corresponds to B 2: {patient, symptom}, {symptom, details}; {patient, medical test}, and {medical test, result}.

### History:

The patient is a fifty four year old male who has a long history of palpitations and typical chest pain. He underwent an echocardiogram in the past, which showed mitral valve prolapsed. He explains his chest pain episodes as burning in nature. They would last for several minutes and are not related with breathing shortness. The patient says that his history of palpitations has improved while he has been on Tenormin.

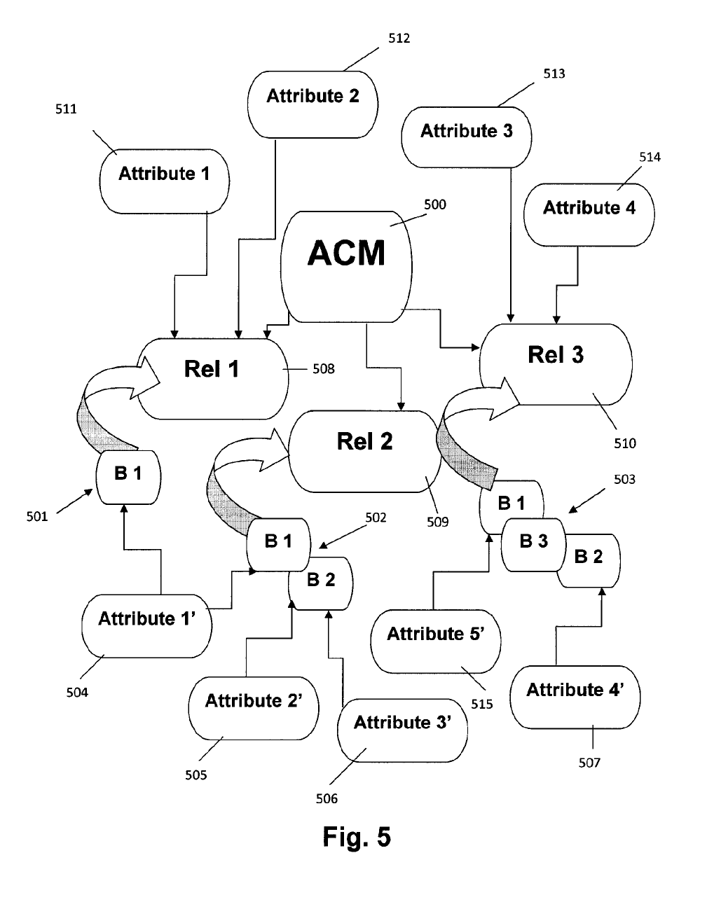

FIG. 5 is a generalized representation of dynamic (relations) and static (entities) sub-domains of the ACM (500). In FIG. 5 the static domain consists of sets of arguments {B 1} (singleton set)(501), {B 1, B 2} (2 argument set)(502), {B 1, B 2, B 3} (3 argument set)(503) and is characterized by specific attributes of each (Attribute 1′(504), Attribute 2′(505), Attribute 3′(506), and Attribute 4′/Attribute 5′(507/515)). In language, this is expressed, for example, as adjectival modification with a number of adjectives as modifiers. The dynamic domain consists of relations Rel 1 (for one argument)(508), Rel 2 (for 2 arguments)(509), and Rel 3 (for 3 arguments)(510) and is characterized by specific attributes of each relation (Attribute 1(511), Attribute 2(512), Attribute 3(513), and Attribute 4(514). In language, this is expressed, for example, as adverbial modification with a number of adverbs as modifiers.

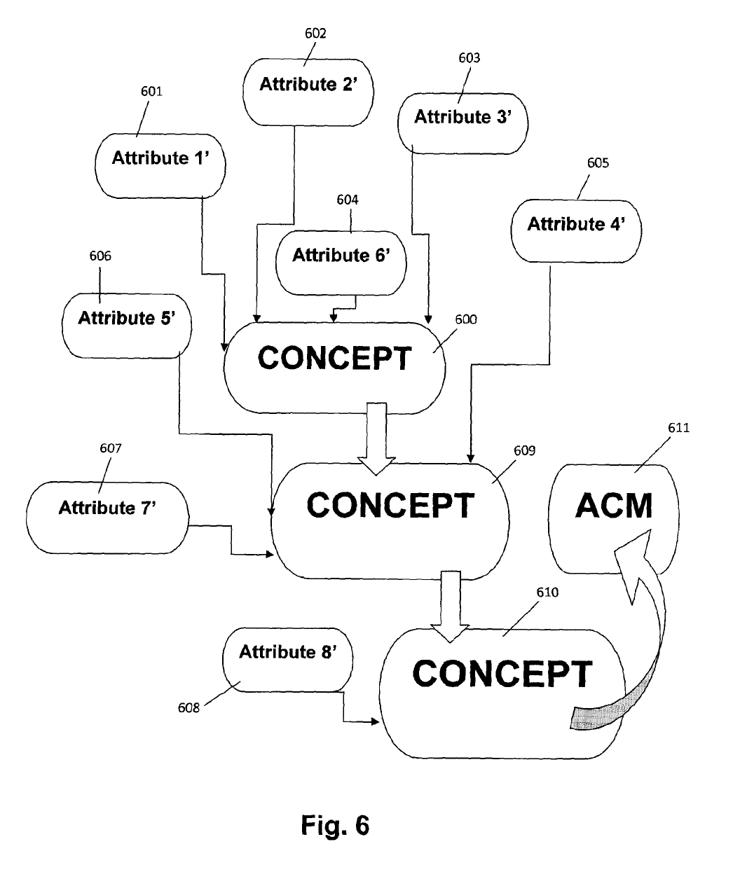

FIG. 6 is a generalized representation of concept formation and its expansion. The current method 611 involves a stage where individuals are instantiated as sets of characteristic features. The representation in FIG. 6 complies with the basic principles of categorization. A cognitive mechanism treats nouns as characteristic features, and establishes a relation between sets of characteristic features and their arguments. The basic rule underlying the mechanism of concept formation is intrinsically connected to our innate ability to define functional domains of different levels: entities, sets of entities, and sets of characteristic features of entities. The cognitive mechanism establishes a relation between sets of characteristic features and their arguments. The relation of set membership is an operation on finite sets of characteristic features. Such sets are defined as finite when limited to their characteristic members at each stage. As an example, in FIG. 6, the process that identifies concept (600) at stage one incorporates a finite set of attributes {1′, 2′, 3′, 6′} represented by 601-604; the process that identifies concept at stage two (expanded concept 609) incorporates a finite set of attributes {4′, 5′, 7′} represented by 605-607; the process that identifies concept at stage three (yet further expanded concept 610) incorporates a finite set of attributes, a singleton set {8′} represented by 608.

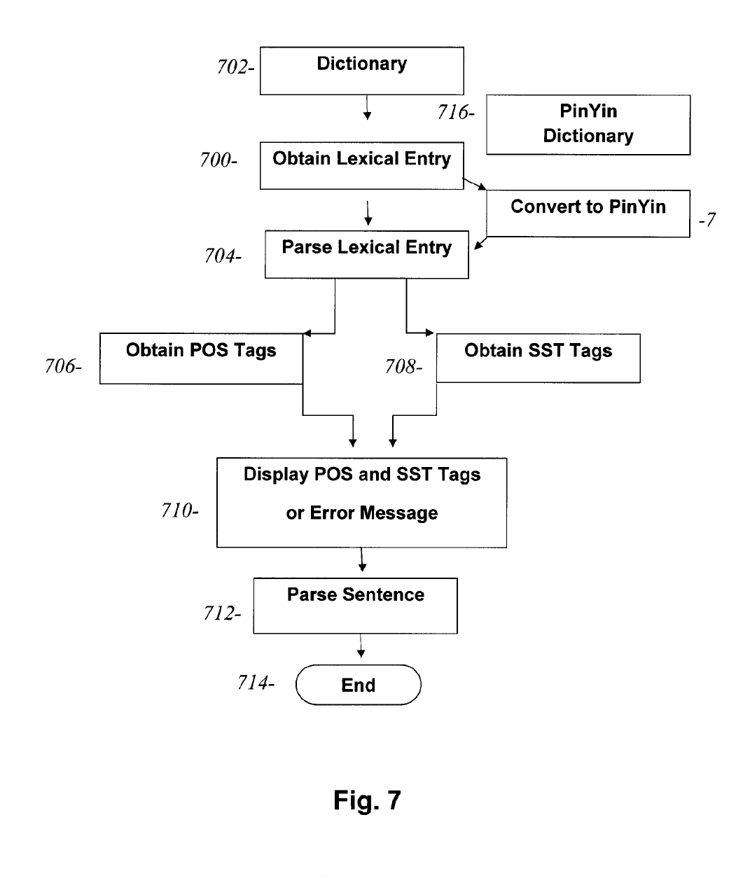

FIG. 7 is a generalized representation of the implementation of present method for natural language processing. Procedure 700 obtains lexical entry, including an image, if in sign language, from a dictionary 702 that includes dictionaries for English, Arabic, Chinese, Spanish, French, Russian, German or American Sign Language (ASL). A number of words in the dictionary 702 can vary depending on how many words have been entered for each language. For example, but not limited to, dictionaries 702 with 5,000, 10,000, 25,000, 30,000, 40,000, 50,000, 100,000, 200,000, 300,000, 400,000, 500,000, 600,000, 700,000, 800,000, 900,000 or 1,000,000 or more word dictionaries 702 could be used. Moreover, the dictionary 702 can be dynamic with new words being added over time.

In the embodiment where the method is applied to processing of the Chinese (Simple) language, the Chinese (Simple) lexical entry is converted to PinYin text 715 from the dictionary 702 and the PinYin text 715 is obtained from a PinYin dictionary 716. For the purposes of this disclosure, Chinese (Simple) refers to Simplified Chinese characters. Both terms are used interchangeably herein.

In FIG. 7 a particular lexical, or image, entry is obtained from dictionary 702 or PinYin dictionary 716. Procedure 704 implements two functions: POS tagging 706 and SST tagging 708. POS Tagger 706 a natural language parser that assigns parts of speech to lexical entries 700. Standard tags are used for POS tagging 706. Lexemes are identified according to tags that correspond to parts of speech (e.g. Adverb (R)). For example:

| | | |
|---|---|---|
| AT article | C conjunction | EX exist. “there” |
| J adjective | N noun | NS plural noun |
| NG genitive noun | O gen. marker (of) | P preposition |
| R adverb | TO inf. marker (to) | V verb |
| VI inf. form | VZ s-form | VPP past participle |
| VG ing-form | VB form of “be” | VH form of “have” |
| VD form of “do” | VM modal | W wh-adverb |
| S sentence | SP sub-sentence | NP noun phrase |
| VP noun phrase | AP adv. phrase | PP prep. phrase |
| JP adj. phrase | PROP start of propos. | QUERY start of query |

In FIG. 7 SST in 708 identifies three types of sentence structure: Subject Verb, Subject Verb Object, Subject Verb Object 1(pronoun/noun) Object 2 (noun) and produces SST-marked output SV, SVO, and SVOO. The word order of the representations below corresponds to the English SVO order. The current system can also handle configurations with different ordering in other languages, such as SOV, VSO, OSV, VSO, and OVS. POS and SST Tags are displayed in 210. SST rules for English simple sentences are shown in Table 1, with illegitimate strings underlined.

TABLE 1
SST Rules for English Simple
Sentences (the illegitimate strings underlined)

| | Item 2: | Item 3: | Item 4: | Item 5: |
|---|---|---|---|---|
| Word | A B | A B C | ABCD | ABCDE |
| 1 | NV | NVN | NVNV | NV/NVN |
| 2 | UV | NVU | NVNN | NVN/NV |
| 3 | VN | UVN | NVUV | UV/NVN |
| 4 | VV | UVU | UVNV | NVN/UV |
| 5 | NN | VVN | UVUV | NV/UVN |
| 6 | UU | VVV | UVNN | UVN/NV |
| 7 | NU | VNN | UVUN | NV/UVU |
| 8 | UN | VNV | NVUN | UVU/NV |
| 9 | | | NNNV | UV/UVU |
| 10 | | | VNNV | UVU/UV |
| 11 | | | NVVN | NV/NVU |
| 12 | | | VVVN | NVU/NV |
| 13 | | | VVNN | UV/NVU |
| 14 | | | VVVV | NVU/UV |

For the embodiment where Chinese(Simple) text is processed, the SST rules for Chinese(Simple) Simple Sentences are shown in Table 2, with illegitimate strings underlined.

TABLE 2
SST Rules for Chinese (Simple) Simple Sentences
(the illegitimate strings underlined)

| | Item 2: | Item 3: | Item 4: | | |
|---|---|---|---|---|---|
| Word | A B | A B C | ABCD | Item 5: ABCDE | |
| 1 | NV | NVN | NVNV | NV/NVN | |
| | | | | NV/NNV | |
| 2 | UV | NVU | NVNN | NVN/NV | |
| | | | | NNV/NV | |
| 3 | VN | UVN | NVUV | UV/NVN | |
| | | | | UV/NNV | |
| 4 | VV | UVU | UVNV | NVN/UV | |
| | | | | NNV/UV | |
| 5 | NN | NUV | UVUV | NV/UVN | |
| | | | | NV/UNV | |
| 6 | UU | UNV | UVNN | UVN/NV | |
| | | | | UNV/NV | |
| 7 | NU | NNV | UVUN | NV/UVU | |
| | | | | NV/UUV | |
| 8 | UN | UUV | NVUN | UVU/NV | |
| 9 | | VVN | NNNV | UV/UVU | UV/UUV |
| 10 | | VVV | VNNV | UVU/UV | UUV/UV |
| 11 | | VNN | NVVN | NV/NVU | NV/NUV |
| 12 | | VNV | VVVN | NVU/NV | NUV/NV |
| 13 | | | VVNN | UV/NVU | UV/NUV |
| 14 | | | VVVV | NVU/UV | NUV/UV |

SST rules for Arabic(Standard) simple sentences are shown in Table 3, with illegitimate strings underlined.

TABLE 3
SST Rules for Arabic (Standard) Simple
Sentences (the illegitimate strings underlined)

| | Item 2: | Item 3: | Item 4: | Item 5: |
|---|---|---|---|---|
| Word | A B | A B C | ABCD | ABCDE |
| 1 | NV | NVN | NVNV | NV/NVN |
| | | | | NV/NNV |
| 2 | UV | NVU | NVNN | NVN/NV |
| | | | | NNV/NV |
| 3 | VN | UVN | NVUV | UV/NVN |
| | | | | UV/NNV |
| 4 | VV | UVU | UVNV | NVN/UV |
| | | | | NNV/UV |
| 5 | NN | NUV | UVUV | NV/UVN |
| | | | | NV/UNV |
| 6 | UU | UNV | UVNN | UVN/NV |
| | | | | UNV/NV |
| 7 | NU | NNV | UVUN | NV/UVU |
| | | | | NV/UUV |
| 8 | UN | UUV | NVUN | UVU/NV |
| 9 | | VVN | NNNV | UV/UVU |
| 10 | | VVV | VNNV | UVU/UV |
| 11 | | VNN | NVVN | NV/NVU |
| 12 | | VNV | VVVN | NVU/NV |
| 13 | | | VVNN | UV/NVU |
| 14 | | | VVVV | NVU/UV |

As mentioned above, the method for natural language processing can be applied to American Standard Sign Language (ASL) images according to an embodiment of the invention. SST rules for ASL simple sentences are shown in Table 4, with illegitimate strings underlined.

TABLE 4
SST Rules for Arabic (Standard) Simple Sentences
(the illegitimate strings underlined)

| | Item 2: | Item 3: | | | | |
|---|---|---|---|---|---|---|
| Word | AB | ABC | Item 4: ABCD | | Item 5: ABCDE | |
| 1 | NV | NVN | NVNV | UVNV | NV/NVN | NV/UVN |
| 2 | UV | NVU | UVUV | NVUV | NV/UVU | NV/NVU |
| 3 | VN | UVN | NVNN | UVNN | UV/UVU | UV/NVN |
| 4 | VV | UVU | NVUN | UVUN | UV/UVU | UV/UVN |
| 5 | NN | VVN | NNVN | NNVU | NVN/NV | NVN/UV |
| 6 | UU | VVV | UUVN | UUVU | UVN/NV | UVN/UV |
| 7 | NU | VNN | NUVN | NUVU | NVU/NV | NVU/UV |
| 8 | UN | VNV | UNVN | UNVU | UVU/NV | UVU/UV |
| 9 | | NNV | NNNV | VNNV | NNV/NV | NNV/UV |
| 10 | | NUV | NVVN | VVNN | UUV/NV | UUV/UV |
| 11 | | UNV | VVVN | VVVV | NUV/NV | NUV/UV |
| 12 | | | | | UNV/NV | UNV/UV |

Sentence parser 712 applies a specific set of rules to boundary absent word strings or to completed sentences to conduct semantic and syntactic parsing. The current system is based on the nominal entities and relations between them, subsequently building upon their role in the syntactic and semantic organization of a sentence. The output is displayed in display 714.

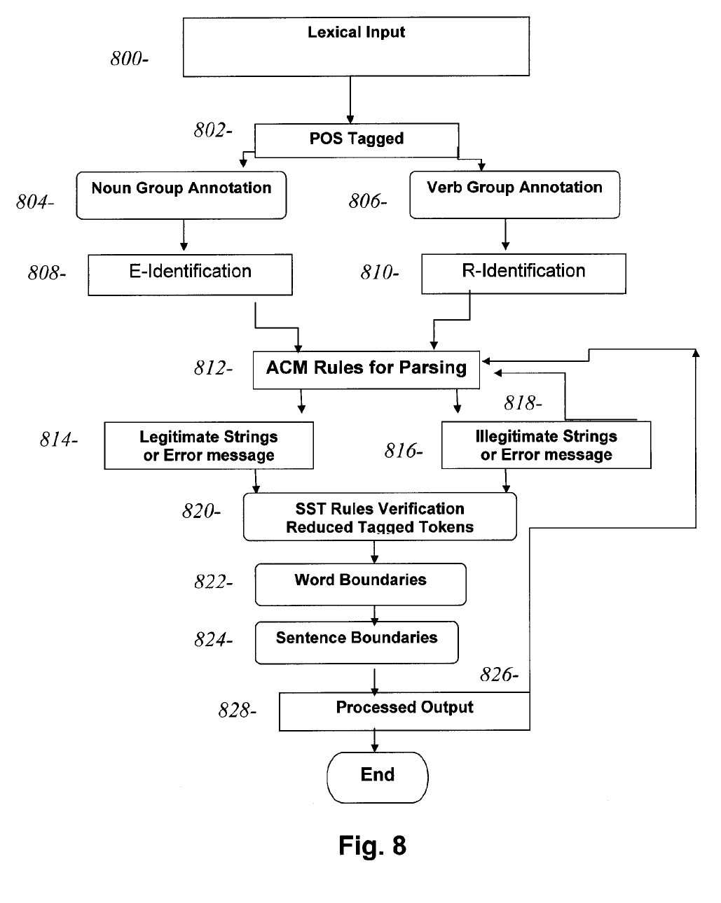

As shown in FIG. 8, the implementation of processing lexical strings in a word-by-word manner to identify relevant argument configurations: entity relation (ER), entity relation entity (ERE), and entity relation entity (relation) entity (ERE(R)E) can be achieved. The implementation consists of identification of three argument configurations underlying this particular invention method, and subsequently developing syntactic and semantic interface analysis.

The limited array of possibilities for the N-Law-based tree of the present method corresponds to the number of E positions available to a term adjoining the tree. This operation either returns the same value as its input or the cycle results in a new element. The recursively applied rule adjoins each new element to the one that has a higher ranking in a bottom-up manner, starting with the term that is ‘Ø-merged first’.

The term A may undergo O-Merge either first or second. The supporting evidence comes from Japanese. The argument position of ‘the girl’ is ‘Ø-merged second’ in the matrix clause and ‘O-merged first’ in the subordinate clause.

Yoko-ga kodomo-o koosaten-de mikaketa onnanoko-ni koe-o kaketa

Yoko child intersection saw girl called ‘Yoko called the girl who saw the child at the intersection’

In the present method, entities (Es) are not limited to nouns but can be also expressed by e.g. non-finite verbal phrases: ‘[To love] should not mean [to suffer]’. Relations (Rs) are expressed not only as verbs by also as prepositions in prepositional phrases, applicative Rs in applicative constructions of the kind ‘Mary baked John a cake_{APPL}’, possessive Rs in possessive constructions of the kind ‘my mother's hat’, etc. The syntactic structures underlying this invention, show consistency in compliance with N-Law.

The bar-level in a tree is eliminated in the present method. Syntactic representations are redefined: lexical elements/entities are combined into clusters where each cluster is a hierarchical structure with the maximal number of 3 elements. Those clusters are arranged according to the rules of a specific language e.g. word order SVO in English. The N-Law justifies the constraints on a number of elements in clusters and the properties of arrangement of these elements in a specific way that assigns a linear order to lexical items.

The process governed by N-Law proceeds by phases. A phase is a completed segment that cannot be broken into parts: ‘Mary likes John’ is a phase, but ‘Mary likes’ is not. The minimal (incomplete) non-propositional phases (e.g. prepositional and applicative) are contained within maximal phases, gradually building up syntactic structures in a manner of embedding one segment within the next one. Any X can in principle head a phase. The strength of the system of revised syntactic trees according to the current method is in its focus on the number and content of the components of these configurations. This approach allows the system to handle any natural language.

As shown in FIG. 8, the method provides for processing lexical strings in a word-by-word manner to establish sentence boundaries for Simple Sentences by identifying relevant argument configurations. The system of implementation of ACM Rules 812 disambiguates syntactic structures and identifies sentence boundaries in text and speech processing. SST system in 812 identifies types of sentence structure: Subject Verb (SV), Subject Verb Object (SVO), Subject Verb Object 1(pronoun/noun) Object 2 (noun) (SVOO) and produces SST-marked output. As shown in FIG. 8, lexical input 800 is POS-tagged 802. The method further includes Verb Group Annotation 806 and Noun Group Annotation 804 to ensure proper E-Identification 808 and R-Identification 810, according to which the strings are classified by ACM Rules for Parsing 812 of the current method as legitimate 814 and illegitimate 816. The SST rules of the present invention are verified by procedure 820. The implementation of ER, ERE, and ERE(R)E configurations underlying this particular method produce Reduced Tagged Tokens 820. Word boundaries are identified by procedure 822 and Sentence Boundaries by semantic web evaluation 824. Parsing proceeds for the identified legitimate strings.

The system is designed in such a way that it contains a look-ahead loop 818; configuration B following a particular configuration A affects the identification of A. This implementation also contains loop 826 ‘Proceed and repeat’.

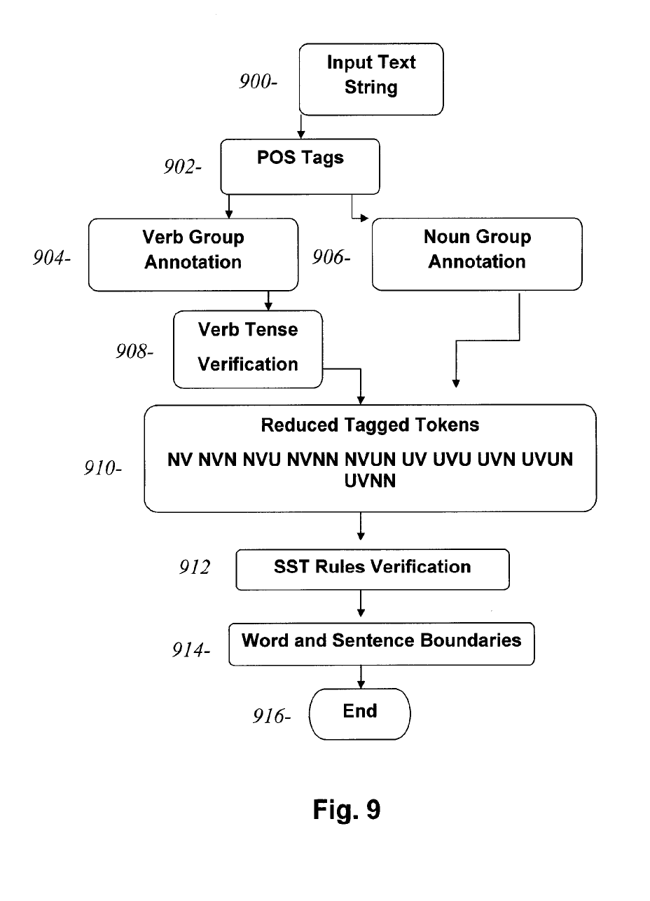

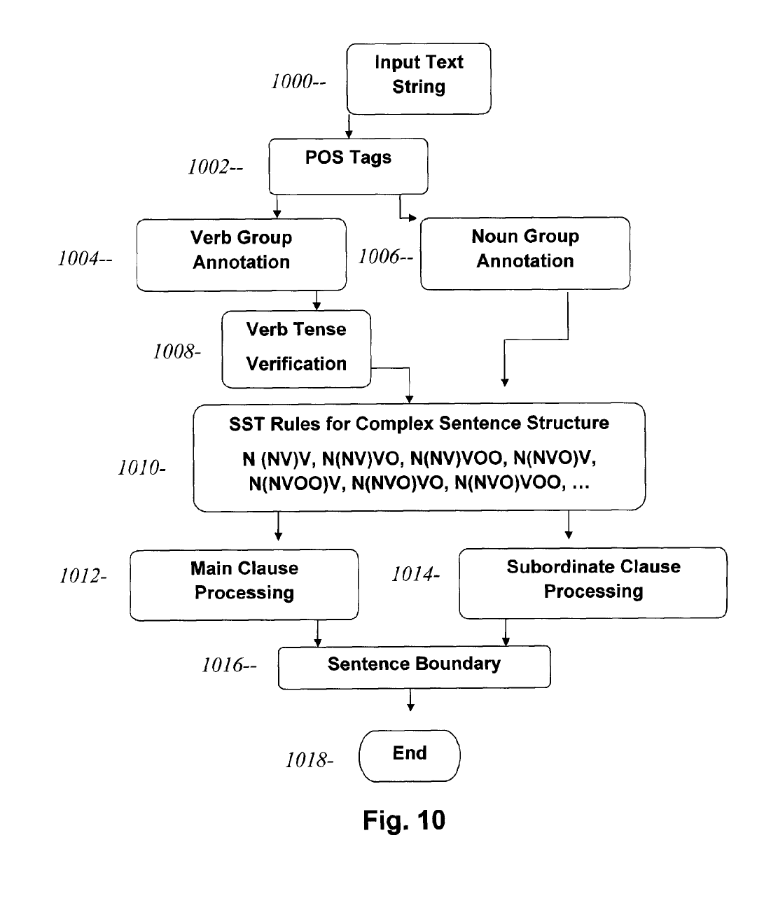

As shown in FIG. 9 a procedure is provided for processing lexical strings in a word-by-word manner to establish sentence boundaries for Simple Sentences by identifying relevant argument configurations. In one embodiment, the PinYin converted Chinese (Simple) Text is used for this purpose. SST system 902 identifies types of sentence structure: Subject Verb (SV), Subject Verb Object (SVO), Subject Verb Object 1(pronoun/noun) Object 2 (noun) (SVOO) and produces SST-marked output. The method further includes Verb Group Annotation 904, Noun Group Annotation 906, and Verb tense Verification 908. The implementation of ER, ERE, and ERE(R)E configurations underlying this particular method produce Reduced Tagged Tokens 910. SST rules of the present invention are verified 912 and Sentence Boundary identified 916. The implementation of processing a lexical string in a word-by-word manner to identify relevant argument configurations for Complex Sentences with embedded clauses of the kind ‘The man [(whom) Mary likes t]_{EMBEDDED CLAUSE} wrote a book’ is shown in FIG. 10. Complex Sentence Structure contains a main clause and one or more subordinate clauses. A wh-word e.g. ‘who(m)’ or ‘that’ marks the beginning of the subordinate clause. The present method solves the binding problem (t_object position of ‘likes’ is bound to ‘The man’, subject of matrix clause). For example, the string E E R R E can be configured as: a) EE/RRE (illegitimate configuration); b) E E R/R E (illegitimate configuration); c) E E R R/E (illegitimate configuration); d)/E R t/(legitimate configuration) and E//R E (legitimate configuration); and e)Eα₁/Eα₂ R_{γ2 transitive} tβ₂(?)/R_{γ1 transitive} Eβ₁.

The rules of phase formation implemented in this way resolve the binding problem. The argument position t of theme of the subordinate clause (embedded sentence) can only be bound to E_{agent1} position of the matrix clause.

SST Rules for Complex Sentence Structure are shown in Table 5.

TABLE 5
SST Rules for Complex Sentence Structure

| | Main Clause | | | Modified |
|---|---|---|---|---|
| | (Simple | | | Embedded |
| # | Structure) | Embedded Clause Structure | | Clause |
| 1 | NV | UV | | |
| 2 | NVN | UVN | UVU | NVU |
| 3 | NVNN | UVNN | UVUN | NVUN |
| | Complex | | | |
| | Sentence | Modified Embedded Sentence | | |
| 4 | N (UV) V | | | |
| 5 | N (UV) VN | N (NV) VU | | |
| 6 | N (UV) VNN | N (NV) VNN | | |
| 7 | N (UVN) V | N (NVN) V | | |
| 8 | N (UVN) VN | N (NVN) VN | N (NVU) VU | |
| 9 | N (UVN) VNN | N (NVU) VNN | N (NVU) | N (NVN) |
| | | | VUN | VUN |
| 10 | N (UVNN) V | N (NVNN) V | | |
| 11 | N (UVNN) VN | (NVNN) VN | N (NVNN) | N (NVNN) |
| | | | VN | VN |
| 12 | N (UVNN) VNN | N (NVNN) VNN | N (NVUN) | N (NVNN) |
| | | | VNN | VNN |

Note
The first word of the main clause is a noun. The first word of the sub-clause is ‘who’, ‘that’, or ‘which’.

In the embodiment where Chinese(Simple) language is processed, the SST rules for Chinese Complex Sentence Structure are used as shown in Table 6.

TABLE 6
SST Rules for Chinese Complex Sentence Structure

| | Main Clause | | | Modified |
|---|---|---|---|---|
| | (Simple | | | Embedded |
| # | Structure) | Embedded Clause Structure | | Clause |
| 1 | NV | UV | | |
| 2 | NVN | UVN | UVU | NVU |
| 3 | NVNN | UVNN | UVUN | NVUN |
| | Complex | | | |
| | Sentence | Modified Embedded Sentence | | |
| 4 | (UV) NV | | | |
| 5 | (UV) NVN | (NV) N VU | | |
| 6 | (UV) NVNN | (NV) N VNN | | |
| 7 | (UVN) NV | (NVN) NV | | |
| 8 | (UVN) NVN | (NVN) NVN | (NVU) NVU | |
| 9 | (UVN) NVNN | (NVU) NVNN | (NVU) N VUN | (NVN) |
| | | | | NVUN |
| 10 | (UVNN) NV | (NVNN) NV | | |
| 11 | (UVNN) NVN | (NVNN) NVN | (NVNN) NVN | (NVNN) |
| | | | | NVN |
| 12 | (UVNN) NVNN | (NVNN) NVNN | (NVUN) NVNN | (NVNN) |
| | | | | NVNN |

An example of embedded clause tags is shown in Table 7.

TABLE 7
Embedded Clause Tags

| # | Part-of-Speech Tag | Sentence Structure Tag |
|---|---|---|
| 1 | N (N1 V1) V | S2 (S1 V1) V2 |
| 2 | N (N1 V1 N2) V | S2 (S1 V1 O1) V |
| 3 | N (N1 V1 N2 N3) V | S2 (S1 V1 O1-1 O1_2) V |
| 4 | N (N1 V1) V N | S2 (S1 V1) V2 O2 |
| 5 | N (N1 V1 N2) V N | S2 (S1 V1 O1) V2 O2 |
| 6 | N (N1 V1 N1 N2) V N | S2 (S1 V1 O1 O2) V2 O2 |
| 7 | N (N1 V1) V N1 N2 | S2 (S1 V1) V2 O2_1 O2_2 |
| 8 | N (N1 V1 N1) V N1 N2 | S2 (S1 V1 O1) V2 O2_1 O2_2 |
| 9 | N (N1 V1 N1 N2) V N1 N2 | S2 (S1 V1 O1 O2) V2 O2_1 O2_2 |
| 10 | N (N1 V1) V N (N2 V2) | S2 (S1 V1) V2 O2 (S3 V3) |
| 11 | N (N1 V1 N1) V N (N2 V2) | S2 (S1 V1 O1) V2 O2 (S3 V3) |
| 12 | N (N1 V1 N1_1 N1_2) V N(N2 V2) | S2 (S1 V1 O1_1 O1_2) V2 O2 (S3 V3) |
| 13 | N (N1 V1) V N_l N_2 (N2 V2) | S2 (S1 V1) V2 O2_1 O2_2 (S3 V3) |
| 14 | N (N1 V1 N1) V N_1 N_2 (N2 V2) | S2 (S1 V1 O1) V2 O2_1 O2_2 (S3 V3) |
| 15 | N (N1 V1 N1_1 N1_2) V N_l N_2 (N2 V2) | S2 (S1 V1 O1_1 O1_2) V2 O2_1 O2_2 (S3 V3) |
| 16 | N (N1 V1) V N (N2 V2 N2) | S2 (S1 V1) V2 O2 (S3 V3 O3) |
| 17 | N (N1 V1 N1) V N (N2 V2 N2) | S2 (S1 V1 O1) V2 O2 (S3 V3 O3) |
| 18 | N (N1 V1 N1_1 N1_2) V N(N2 V2 N2) | S2 (S1 V1 O1_1 O1_2) V2 O2 (S3 V3 O3) |
| 19 | N (N1 V1) V N (N2 V2 N2_1 N2_2) | S2 (S1 V1) V2 O2 (S3 V3 O3_1 O3_2) |
| 20 | N (N1 V1 N1) V N (N2 V2 N2_1 N2_2) | S2 (S1 V1 O1) V2 O2 (S3 V3 O3_1 O3_2) |
| 21 | N (N1 V1 N1_1 N1_2) V N(N2 V2 N2_1 N2_2) | S2 (S1 V1 O1_1 O1_2) V2 O2 (S3 V3 O3_1 O3_2) |

For the purposes of illustration, input string 1000 of FIG. 10 could be a complex sentence from the Chinese(Simple) language, such as ‘ [symbol] ’ (‘I know who sings’). Complex Sentence Structure contains a main clause and one or more subordinate clauses. A string ‘ [symbol] ’ (‘who’) marks the beginning of the subordinate clause. Similarly, an input string 1000, such as

[symbol]

[symbol]

[symbol]

[symbol]

could be obtained for the Arabic language.

As shown in FIG. 10, the Subordinate Clause processing step 1014 takes place as follows: POS are treated in succession following SST rules of the present system. The sub-clause is extracted from the main sentence when the first entity—wh-word ‘who’, ‘that’, or ‘which’, a nominal trace—is found. In the Chinese(Simple) example, the sub-clause ‘ [symbol] ’ (‘who sings’) is extracted from the main sentence when the first entity—‘ [symbol] ’ ‘who’, a nominal trace—is found. Similarly, in the Arabic language example, the sub-clause ‘ [symbol] ’ is extracted from the main sentence when the first entity—‘ [symbol] ’, a nominal trace—is found. After which, the second element—verb of the subordinate clause—is found.

When no argument is found following V, the POS tag is NV and the sub-clause SST tag is SV. When entity count is 3 (the second word is V, the third word is N or U), the POS tag is NVN or NVU and the sub-clause SST tag is SVO. When the word count is 4 (the second word is V, the third word is N or U, the fourth word is N), the POS tag is NVNN or NVUN and the SST tag is SVOO.

The Main Clause processing step 1012 takes place as follows: the main clause is found when a noun is in the initial position followed by ‘who’, ‘ [symbol] ’, ‘ [symbol] ’ The parser skips the already processed Subordinate Clause. When the word count of the Main Clause is 2 (the second word is V), the POS tag is NV and the SST tag is SV. When the word count is 3 (the second word is V followed by N or U), the POS tag is NVN or NVU and the SST tag is SVO. When the word count is 4 (the second word is V followed by N or U, and the fourth word is N), the POS tag is NVNN or NVUN and the SST tag is SVOO.

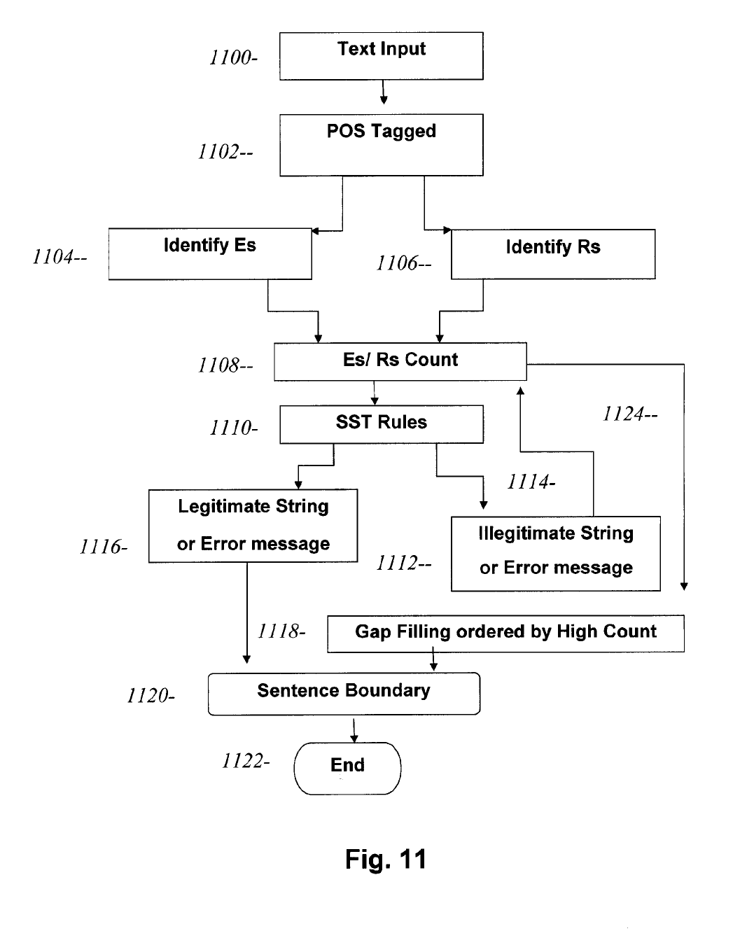

The implementation of processing lexical strings in Simple Sentences in a word-by-word manner to fill the gaps by identifying relevant argument configurations is shown in FIG. 11. The lexical input 1100 is POS-tagged 1102 to ensure proper Entity Identification 1104 and Relation Identification 1106, according to which the strings are classified by SST Rules 1110 of the current method as legitimate 1116 and illegitimate 1112. Parsing proceeds for the identified legitimate strings. The system is designed in such a way that it contains look-back and look-ahead loops 1114 and 1124; configuration B following a particular configuration A affects the identification of A. SST Rules 1110 disambiguate syntactic structures and identifies sentence boundaries in text and speech processing, and fills in the gaps. The output produces syntactically and semantically correct sentences with the gaps filled by relevant lexical terms. Drop-down menus can be provided to offer a list of lexical items to be selected from by the user for each gap.

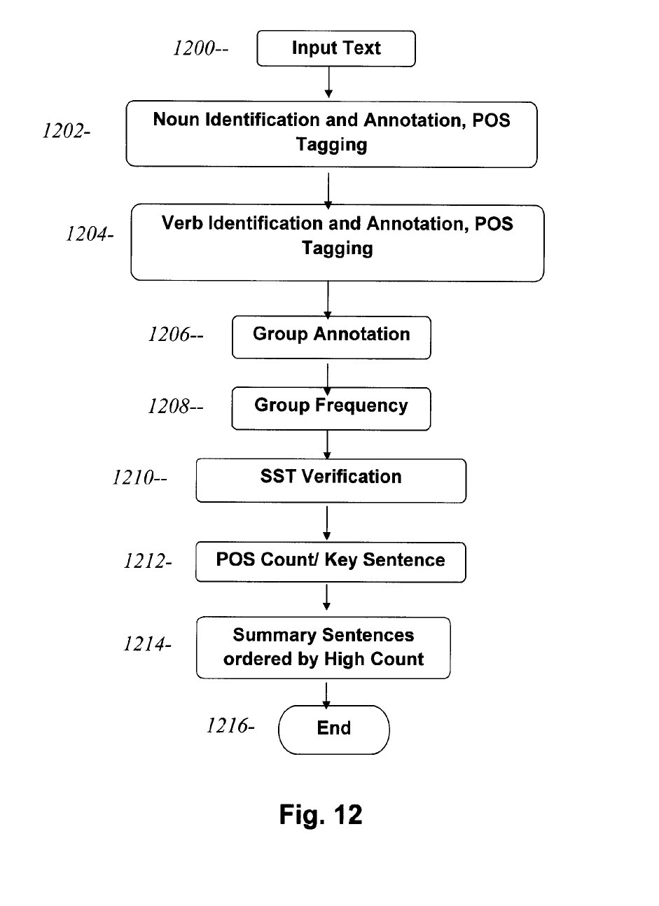

FIG. 12 is the implementation of processing simple texts in a word-by-word manner to produce a summary of a given text by identifying relevant argument configurations. The lexical input 1200 is POS-tagged (1202 nouns and 1204 verbs). The data entries are parsed as POS data indicating parts of speech for the tokens in the paragraphed text of the file. The POS data is contained in the dictionary; the input word is matched by the POS-tagged word. It is used to obtain the ‘group’ data 1206, or the groups of tokens of the text, such as verb groups and noun groups. Based on Group Frequency results 1208 and POS count 1212 to identify the key ‘summary’ sentence is extracted by eliminating irrelevant groups.

The following input text was processed in accordance with the steps shown in FIG. 12.

A. Input English sentences ‘A big black cat eats meat and fish in the kitchen’. A small while dog eats meat in the kitchen. The dog sleeps in the garden.’

In the first step of the method, parts of speech, such as nouns (N), verbs (V) and adjectives (J) are identified:

B. POS Tagging AJJNVNCNPAN/AJJNVNPAN/ANVNPAN

Next, the legitimate configurations are identified using SST Rules shown, for example, in Tables 1-4, (i.e. ER and ERE are legitimate (expressed as NV and NVN), while RE is not. Afterwards, Sentence Structure Tagging (i.e. which sentences are ER, ERE or EREE) is obtained:

C. SST Tagging SVO/SVO/SV

Next, in the group annotation step the most frequent configurations are identified, in this case ERE expressed as NVN. POS count identifies corresponding units that are found in both configurations: A(article), NVN (ERE construct), PAN (prepositional construct).

D. Group Annotation, POS Count SVO/AJJNVNCNPAN, SVO AJJNVNPAN

Based on Group Annotation and POS count, a frequency/“high count” of constructs and participating lexical items is established:

E. High Count ‘a cat’, ‘a dog’, ‘meat’, ‘in the kitchen’.

F. Summary: “A cat and a dog eat meat in the kitchen’.

The following input text was processed in accordance with the steps shown in FIG. 12. and FIG. 9.

A. Input a string of words ‘mom comes dad comes mom sees dad mom wants milk I give mom milk mom drinks milk’

B. POS Tagging, SST Tagging, Sentence Boundaries

mom comes/dad comes/mom sees dad/mom wants milk/I give mom milk/mom drinks milk SV/SV/SVO/SVO/SVOO/SVO

D. Group Annotation

Subject—NG: mom, dad, mom, mom, I, mom, mom/VG: comes, comes, sees, wants, give, drinks/Object—NG: dad, milk, milk, milk

E. Frequency

Subject—Noun ‘mom’ (4)/Verb ‘comes’ (2)?Object-Noun ‘millk’(3)

F. Summary ‘mom drinks milk’.

The following input text was processed in accordance with the steps shown in FIG. 10. Input Chinese (Simple):

[symbol]

[symbol]

[symbol]

‘A big black cat eats meat and fish in the kitchen. A small white dog eats meat in the kitchen. The dog sleeps in the garden.’

POS Tagging: JJNVNCNPN/JJNVNPN/NVNPN

SST Tagging: SVO/SVO/SV

Group Annotation: SVO/JJNVNCNPN, SVO/JJNVNPNPOS Count, High Count:

[symbol]

Summary:

[symbol]

### Example

The following input text was processed in accordance with the steps shown in FIG. 10. Input a string of words Chinese (Simple):

[symbol]

[symbol]

[symbol]

‘mom comes dad comes mom sees dad mom wants milk I give mom milk mom drinks milk’

POS Tagging: NVNVNVNNVNUVNNNVN

SST Tagging: SVSVSVOSVOSVOOSVO

Sentence Boundaries: SV/SV/SVO/SVO/SVOO/SVO

[symbol]

[symbol]

[symbol]

Group Annotation:

Subject—Nominal Group:

[symbol]

[symbol]

Verbal Group:

[symbol]

[symbol]

Object—Nominal Group:

[symbol]

Frequency: Subject-Nouns [symbol] (4)/Verb [symbol] (2)/Object-Noun [symbol] (3)

Summary:

[symbol]

[symbol]

The following input text was processed in accordance with the steps shown in FIG. 10.

Input Arabic (Standard):

[symbol]

[symbol]

[symbol]

POS Tagging: AJJNVNCNPNAJJNVNPNANVNPN

SST Tagging: SVOSVOSV

Sentence Boundaries Identification:

AJJNVNCNPN/AJJNVNPN/ANVNPN; SVO/SVO/SV

Sentence Boundaries Output Arabic (Standard):

[symbol]

[symbol]

[symbol]

Group Annotation: SVO/JJNVNCNPN, SVO/JJNVNPN

POS Count, High Count:

[symbol]

Summary:

[symbol]

The following input text was processed in accordance with the steps shown in FIG. 10.

Input a string of words Arabic (Standard):

[symbol]

[symbol]

POS Tagging: NVNVNVNNVNUVNNNVN

SST Tagging: SVSVSVOSVOSVOOSVO

Sentence Boundaries: SV/SV/SVO/SVO/SVOO/SVO

Sentence Boundaries Output Arabic (Standard):

[symbol]

[symbol]

[symbol]

Group Annotation:

Subject—Nominal Group:

[symbol]

Verbal Group:

[symbol]

[symbol]

Object—Nominal Group:

[symbol]

Frequency Subject-Noun (4):

[symbol]

Frequency Verb (2):

[symbol]

Frequency Object-Noun (3):

[symbol]

Summary:

[symbol]

According to the postulates of predicate analysis, G(x)(a) is a saturated one-place predicative expression, where G is a set of objects with a certain property (e.g. ‘being green’), and x is a variable in a function which attributes any object possessing this property to the set, and a (e.g. ‘apple’) is a constant which saturates the function. Thus, G(a) is a formal expression of a sentence ‘An apple is green’. For a two-place predicate such as ‘like’, a formal sentential expression will be L(x,y)(a,b) ‘Ann likes books’ where x is ‘the one who likes something’ individual, y stands for any entity that ‘is liked’; a and b are constants. In a set theory, individual constants and variables are expressions of type e (entity), and formulas are expressions of type t (truth values); predicates require saturation by an argument to form an expression; unsaturated arguments cannot be considered to form a clause. A one-place predicate is an expression of type <e,t> which is a function from individuals to truth values. The function checks whether a certain element belongs to a given set. Two-place predicates are the expressions of type <e,<e,t>>.

When the expression L is applied to an individual constant b in L(x)(y))(a)(b), it results in a one-place predicate L(x)(b), or L(b) of type <e,t>, which expresses a property of ‘liking books’. The lambda operator λ is a means of forming new expressions from expressions by abstracting over variables. For example, if G is a constant of type <e,t> and x a variable of type <e>, then G(x) is a formula in which x appears as a free variable. The expression λ(x)G(x) can be formed from G(x) by means of lambda-notation by abstracting over the free variable x. Furthermore, the expression λ(x)λ(y)(L(y)(x)) is of type <e,<e,t>>, since it is formed by abstraction over a variable of type <e> in an expression of type <e,t>. The application of lambda-notation by stages is presented below for purposes of formal translation for a two-place predicate ‘likes’ in ‘Ann likes books’.

Stage I. Apply constant b (books) to a two-place predicate λ(x)λ(y)(L(y)(x)) which expresses a property of ‘liking’. The result is a one-place predicate λ(x)(L(y)(b)) which expresses a property of ‘liking books’.

Stage II. Apply constant a (Ann) to a one-place predicate λ(x)(R(y)(b)) The result is a sentence of the form R(a)(b)

A. One-place predication G(x)(a)<e,t> λ(x)λ(y)(G(y)(x)) ‘An apple is green’.

B. Two-place predication L(x,y)(a,b)<e,<e,t>> λ(x)L(x) ‘Ann likes books’.

Problems with a theory that postulates type-preserving formalizations are as follows: a requirement for the ordering of constant application (Problem 1), and the increased complexity of a model (Problem 2).

Problem 1: Is linearization/ordering of stages bottom-up (A) or top-down (B)? A. Apply b (books) to a two-place predicate λ(x)λ(y)(L(y)(x)) ‘liking’. λ(x)(L(y)(b)) ‘liking books’.

B. Apply a (Ann) to a one-place predicate λ(x)(L(y)(b)), L(a)(b)

Problem 2: Representations for predicative/modificational adjectives exhibit increased complexity:

| | | |
|---|---|---|
| A. | An apple is green | <e, t> |
| B. | Green is a color | <<e, t>, <<e, t>, t>> |
| C. | A green apple is sweet | <<<e, t >, <e, t>>, <<<e, t>, <e, t>>, t>> |

The solution to these problems lies in the monadic (binary) structures at each and every level of semantic analysis.

Natural languages make a distinction between arguments, or objects, represented by nouns, and properties, represented by verbs and adjectives. A basic feature of human perception is expressed by naming at an early stage of speech development and by a simple sentence construction at a more advanced stage. Children have the innate ability to distinguish between predicates and their arguments. Properties are acquired at a more advanced stage; children distinguish between kinds of objects prior to identifying properties of individual objects. Thus, language acquisition shows a switch from conceptualization of sets of objects to sets of characteristic features of objects.

In the method, the relations between the elements of conceptual domains operate on the sets representing different levels of cognitive specificity. The postulate of formal logic is that a relationship holds between an object and a set of similar objects. When objects are concepts, the relation holds between sets of Characteristic Features (CF) and their inputs. This representation shows no structural difference between entities instantiated as sets of CF. The core property of conceptualization is the requirement for saturation which establishes uni-directional links between concepts and their inputs. At one stage, individuals come solely as representatives of homogeneous sets, and at another stage as sets of CFs. For example, kitty is a representative of a class of cats; it is also a set of CFs characteristic of cats. The Law of Type-Shift (experiential recursion) allows the objects (or entities of the type <e>) to have a level of representation as sets of characteristic CFs f<f,t>, or <e,t> where f is an entity <e> of the given level. A property has a parallel representation as a set of salient objects <e,t>. Because the same object cannot be instantiated as <e> and <e,t> simultaneously, Type-Shift is a necessary condition for establishing predication links on different levels of cognitive specificity. This kind of Type-Shift permits both type-raising (̂) from <e> to <e,t> and type-lowering (V) from <e,t> to <e>.

The method parallels conceptualization, an important part of the human cognition. Computational operations on representations account for mental processes (changes in brain states). Similarly, the essential attributes of language are derived from general principles. The analyses are accomplished by a set of primitive computational processes in the form of a computer program. The semantic operators of the model perform a specific cognitive task on semantic primitives: attributes, events, states, etc., and produce results similar to data from human performance through the use of a framework that involves atomic processing units.

Syntactic and semantic rules are determined in the method in compliance with the Law of Type-Shift for semantics and the Law of Preservation for syntax. A finite set of principles at each level of the structural as well as of the interpretative domains of natural language eventually eliminates the interface component.

In one embodiment, the method can be used to search a particular text for a particular sentence. Search a word or a structured group of words under the following conditions: The word must be in the dictionary first. There is no special characters like “! $ % ? & *=−, . #” or integers (1, 2, 3, 4, 5, 6, 7, 8, 9, 0). The minimum word length is 1 and the maximum word length is 50. The maximum text length is 32767. The maximum search result is 100. The search area is text (not image, music, video, or other formats). The search location: any file system not in the web. The searched file extensions: 16. 16 File types: “*.doc”, “*.docx”, “*.htm”, “*.html”, “*.xml”, “*.txt”, “*.pdf”, “*.aspx”, “*.wps”, “*.htx”, “*.rtf”, “*.csv”, “*,xsd”, “*.dtd”, “*.config”, “*.xsl” Search results: matched sentences and a file containing relevant sentences, total number of the sentences and total number of the files, folder name.

Response to query:

When a question is entered, answer is found;

When a string of words is entered, semantically related sentences are found;

When a word is entered, the data source of the word entry is found—the title of the document, or the attachment of the file.

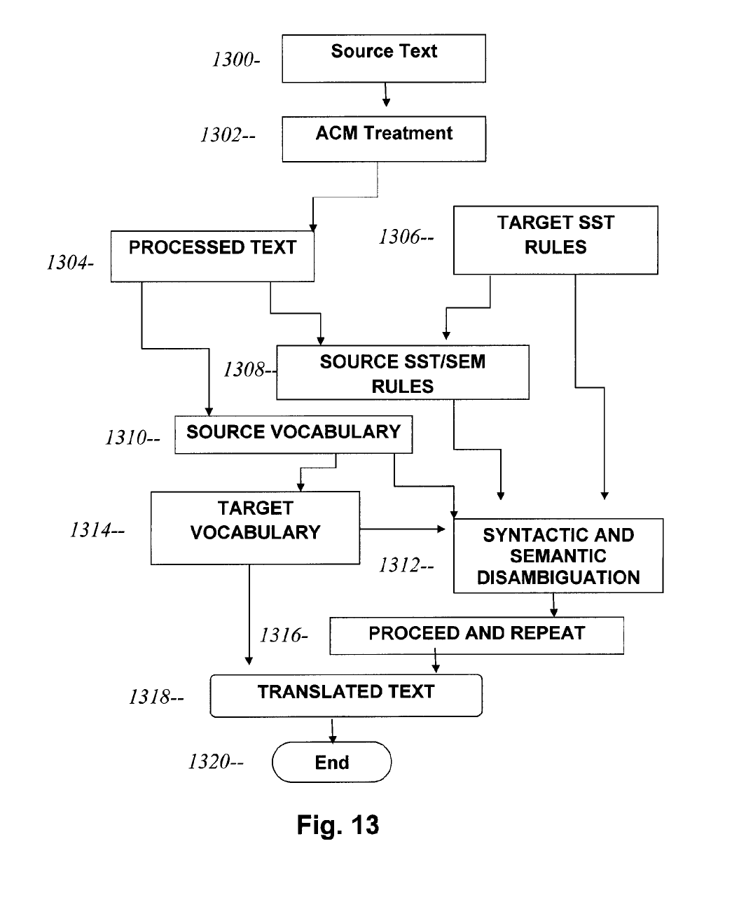

As shown in FIG. 13, the method can be used for translating a text 1300 from a source language to a target language 1318. The translation is implemented by a computer or some other form of electronic means. The translation is performed by means of parsing the source text by treating in ACM its language-specific parameters of its Sentence (grammatical) Structure rules and

Semantic (interpretative) Structure rules in parallel 1308. These parameters are reset to the target language parameters 1312 for the purposes of syntactic and semantic disambiguation. The source vocabulary 1310 and the target vocabulary 1314 are matched depending on the output of the interface disambiguation in 1312.

The existing computer programs such as online translation programs generally produce syntactic errors and semantically ambiguous outputs. Application of the method to translation from a source language into a target language is not restricted by the rules of a specific language. This application results in a reduced number of errors.

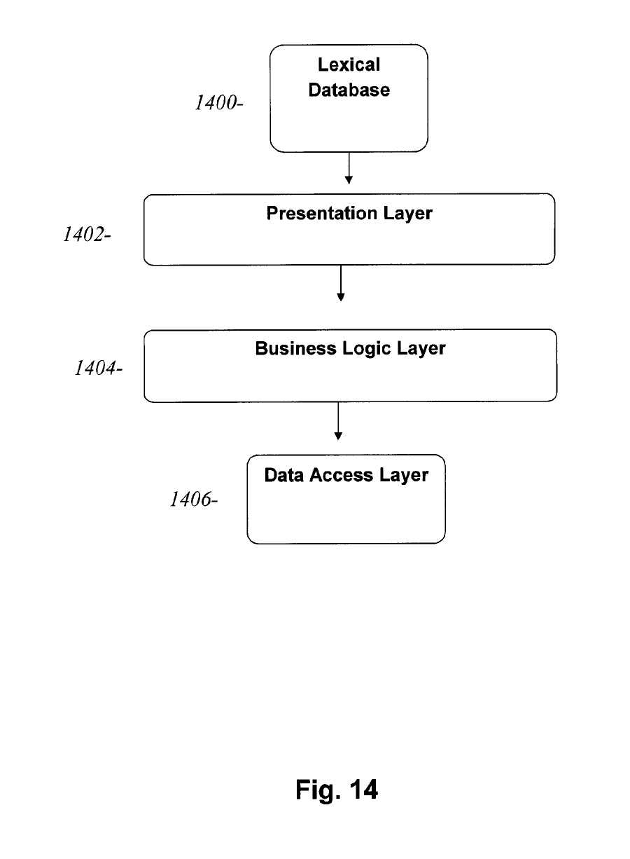

FIG. 14 shows the 3-Tier architecture of Natural Language Processor NLPr running the method of the invention. NLPr ACM V 1.0 is a window application of C# created on Microsoft Framework 3.5. The project runs on window platform with a 3-Tier architecture that generally contains Presentation Layer UI, Business Access (or Logic) Layer, and Data Access Layer. The project processes standard language entities (lexical entries, sentences) with an output of the part-of-speech POS tags, and sentence structure SST tags. UI contains window forms where the data is presented to the user and the input 1400 is received from the user. The main form is the screen that receives the user's entries and the presentation of the final results of the language processing 1402. In one embodiment, English words or simple sentences are inputted for illustrative purposes, but other languages, such as, but not limited to, Russian, Arabic, Spanish, French, and Chinese. Business Access Layer 1404 contains business logic: validations or type conversions on the data. Some functions related to the business logic (language procedures) are collected in the middle-tier, thus separated from the frontal layer. Data Access Layer 1406 contains methods that help Business Layer to connect the data and perform required functions on the data (insert, update, delete, etc).

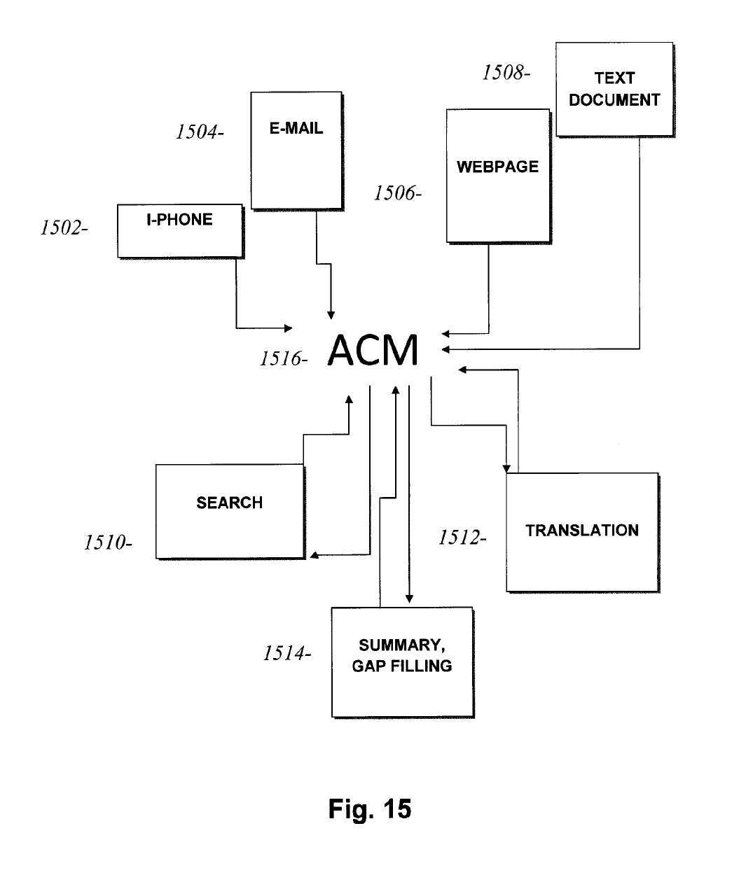

FIG. 15 is an illustration of applications for the natural language processor of the present invention. The processor 1516 includes an input device for receiving the linguistic input, a processing device, a memory device, and an output device. The processor electronically receives the language input in the form of: a text document 1508, a part of the unstructured text information contained in electronic mail 1504, or a text message received via smartphone transmission 1502. The linguistic input is processed and the output is produced depending on the user's needs such as search 1510, summary/gap filling 1514, and translation 1512.

In the case of ASL, the processor could include a processing device that includes, in addition to the elements listed above, an image recognition device and an output image device. In addition to the language inputs noted above, the language input for ASL could include webpage text, an image message received via a smartphone transmission or ASL presentation (talk). The linguistic input in this case is processed and the corresponding ASL output or S/WL output is produced depending on the user's needs, such as translation.

In some cases, the processing device alternatively includes a language receiver device or brain signal receiver device.

The present invention has been described with regard to one or more embodiments. However, it will be apparent to persons skilled in the art that a number of variations and modifications can be made without departing from the scope of the invention as defined by the claims.

### EXAMPLES

### Example 1

For the purposes of implementation of the method, a limited ‘child language’ dictionary was created. The English Dictionary of the invention contained approximately 350 words.

NOUN—N

ANIMAL, APPLE, ATTIC, BANANA, BABY, BALLOON, BALL, BEAR, BEDROOM, BATH, ROOM, BED, BIKE, BOOK, BOY, BODY, BOWL, BREAD, BROTHER, BOAT, BOOKCASE, BUS, BUTTON, CAR, CARPET, CAKE, CAT, CAKE, CHAIR, CEILING, CHICKEN, CIRCLE, CLOUD, CLOTHES, COOKER, COAT, COW, DAD, DAY, DOG, DOOR, DOWN, STAIRS, EAR, ELEVATOR, ORANGE, FISH, EIGHT, EYE, FACE, FOUR, FIVE, FOOD, FOOT, FIRE, ELEPHANT, FRIDGE, FAMILY, FRUIT, FINGER, GARDEN, GIRL, GRANDMA, GRANDPA, GRAPE, HAND, HAIR, HEAD, HEART, HOME, HOUSE, LEG, JUMP, JACKET, KITCHEN, KID, LAP, LEMON, LOBBY, LION, MANGO, MARY, MOON, MOM, MILK, MOUTH, NAME, NINE, NIGHT, NOSE, ONE, PENCIL, PEAR, PLUM, PORCH, PIE, PIG, ROOM, ROOF, RAIN, SIX, SEVEN, SHOWER, SNOW, SHOULDER, SKIRT, SHORTS, SHOE, SOCKS, SOFA, STORM, SISTER, SCISSORS, STAR, STAIRS, SKY, SUN, SUMMER, SQUARE, STOOL, TABLE, TEETH, TEN, THAT, TOILET, TOY, TREE, TRIANGLE, TWO, THREE, T-SHIRT, TOMATO, UPSTAIRS, VEGETABLES, WALL, WATER, WHO, WITCH, FISH, WINDOW, WIND

PRONOUN—Pn—U

I, YOU, SHE, HE, IT, WE, THEY, ME, HER, HIM, US, THEM

VERB—V

AM, ARE, ASK, CALL, CARRY, CRY, CUT, DRINK, LOOK, SEE, WANT, GO, COME, GET, PUT, TAKE, DO, KISS, RUN, SING, POINT, LOVE, EMBRACE, LIKE, TOUCH, GIVE, IS, BRING, SAY, SHOW, SPEAK, SIT, SLEEP, WALK, HAVE, EAT, OPEN, CLOSE, HOLD, TURN, MOVE, LAUGH, SMILE, LISTEN, SHOUT, DANCE, JUMP, SHUT, OPEN, FLY, SAIL, DRIVE, RIDE, MISS, TURN, PLAY, ROLL, WAVE, BEEP, RING, HUG, SWIM, SWING, MOVE, KICK, WHISPER, LISTEN, WASH, BARK, WAIT, HIDE, SEEK, FALL, TALK, STOP, START, WORRY, NEED, FREE, CLIMB, STEP, RUN, PICK, BEAT

ADJECTIVE—J

BIG, SMALL, GOOD, BAD, BRIGHT,SWEET, LONG, SHORT, HIGH, LOW, HOT, COLD, COOL, YOUNG, OLD, FAST, SLOW, UGLY, BEAUTIFUL, PRETTY, SOFT, WARM, LOUD, QUIET, RED, YELLOW, BLUE, BROWN, GREEN, HAPPY, SAD, ANGRY, TIRED, SUNNY, WINDY, CLOUDY, HUNGRY, LITTLE, OLD, NEW, TEDDY, FREE, STRONG, TINY, WHOLE, DARK, TALL

ADVERB—R

SLOWLY, QUICKLY, LOUDLY, QUIETLY, SOFTLY, WARMLY, BADLY, NICELY

CONJUNCTION—C AND, OR, BUT, SO, THEN, THEREFORE, EITHER . . . OR, NEITHER . . . NOR

PREPOSITION—P

ABOVE, IN, ON, BESIDE, BETWEEN, BELOW, BEHIND, UNDER, UP, DOWN, OFF, OVER, OUT, BY, AT, FOR, AROUND, BEFORE, BEYOND, INTO, WITH, WITHOUT, UNDERNEATH, THROUGH, OPPOSITE

As mentioned above, words were given a part of speech POS tag and a sentence structure SST tag.

The following input text was processed in accordance with the steps shown in FIG. 7 by means of the input devices for receiving the linguistic input shown in FIG. 15.

Lexical Input I have a big cat and a small dog. I give the big cat water.

POS Output U V AT J N C AT J N/U V AT J N N

The following input text was processed in accordance with the steps shown in FIG. 7 by means of the input devices for receiving the linguistic input shown in FIG. 15.

Lexical Input A dog runs. A cat drinks water. Dad comes. The cat catches the dog.

SST Output SV/SVO/SV/SVO

The following input text was processed in accordance with the steps broadly defined in FIG. 7 by means of the input devices for receiving the linguistic input shown in FIG. 15.

Lexical Input Mom sleeps. I read a book. I give you a book. You smile. You show me a cat.

SST Output SV/SVO/SVOO/SV/SVOO

The following input text was processed in accordance with the steps broadly defined in FIG. 7 by means of the input devices for receiving the linguistic input shown in FIG. 15.

Lexical Input Mom smiles. I want water. She gives me milk.

POS/SST Output NV/SO//UVN/SVO//UVUN/SVOO

Applying the steps of the method shown in FIGS. 7-9, a plurality of words can be converted into one or more meaningful sentences by means of the input devices for receiving the linguistic input shown in FIG. 15.

Lexical Input i like a cat mom shows me a book i give her a banana she smiles i smile

POS/SST Output UVN/NVUN/UVUN/UV/UV SVO/SVOO/VOO/SV/SV

Sentence boundaries UVN/SVO//NVUN/SVOO//UVUN/SVOO//UV/SV//UV/SV

Parsed Output I like a cat. Mom shows me a book. I give her a banana. She smiles. I smile.

### Example 2

For the purposes of implementation of the method, a limited ‘child language’ dictionary was created. The Chinese (Simple) and PinYin Dictionary of the invention contained approximately 350 words.

NOUN—N

Chinese (Simple) { [symbol] [symbol] [symbol] [symbol] [symbol] [symbol] [symbol] [symbol] [symbol] [symbol] };

PinYin {“mao”, “gou”, “ba”, “ma”, “baba”, “mama”, “jie”, “di”, “mianbao”, “nvhai”, “nanhai”, “shui”, “yanjin”, “erduo”, “mali”, “yingyu”, “niunai”, “yinger”, “jia”, “shiwu”, “shu”, “guozhi”, “tangguo”, “xiangjiao”, “pingguo”, “yu”, “xia”, “wawa”, “yizi”, “zhuozi”,“chuang”, “tanzi”, “zhentou”, “taiyang”, “yu”, “xue”, “shu”, “niao”, “hua”};

VERB—V

Chinese (Simple) Verb 1:

{ [symbol] [symbol] };

Chinese (Simple) Verb 2 { [symbol] [symbol] };

PinYin {“shi”, “wen”, “jiao”, “dai”, “ku”, “kan”, “he”, “kan”, “kanjian”, “yao”, “zhou”, “lai”, “na”, “fang”, “zhuo”, “wen”, “pao”, “chang”, “zhi”, “lai”, “bao”, “xihuan”, “muo”, “gei”, “shuo”, “zhuo”, “shui”, “shanbu”, “chifan”, “chang ge”, “tiaowu”, “xiao”, “shi”, “fasong”, “jieshou”, “wen”, “hen”, “xihuan”, “ai”};

PRONOUN—U

Chinese (Simple) Pronoun 1 { [symbol] };

Chinese (Simple) Pronoun 2 { [symbol] };

PinYin {“wo”, “women”, “tamen”, “ta”, “ni”, “nimen”};

ADJECTIVE—J

Chinese (Simple) Adjective 1 { [symbol] [symbol] };

Chinese (Simple) Adjective 2 { [symbol] [symbol] [symbol] };

PinYin {“da”, “xiao”, “hao”, “huai”, “tiande”, “re”, “len”, “niang”, “chang”, “duan”, “chou”, “dashengdi”, “anjingde”, “kuai”, “man”, “bai”, “hong”, “huang”, “hei”};

ADVERB—R

Chinese (Simple) Adverb 1 { [symbol] };

Chinese (Simple) Adverb 2 { [symbol] };

PinYin {“zhai”, “hen”, “feichang”, “tai”, “jiu”, “hao”, “you”, “jiqi”, “kuaidian”}.

### Example 3

For the purposes of implementation of the method, a limited ‘child language’ dictionary was created. The Simple Arabic and Arabic Dictionary of the invention contained approximately 350 words.

NOUN—N Arabic (Standard):

[symbol]

[symbol]

[symbol]

[symbol]

VERB—V Arabic (Standard):

[symbol]

PRONOUN—U Arabic (Standard):

[symbol]

ADJECTIVE—J Arabic (Standard):

[symbol]

[symbol]

[symbol]

ADVERB—R Arabic (Standard):

[symbol]

[symbol]

### Example 4

For the purposes of implementation of the method, a limited ‘child language’ dictionary was created. The ASL Dictionary of the invention contained approximately 350 words.

NOUN—N

ANIMAL, APPLE, ATTIC, BANANA, BABY, BALLOON, BALL, BEAR, BEDROOM, BATH, ROOM, BED, BIKE, BOOK, BOY, BODY, BOWL, BREAD, BROTHER, BOAT, BOOKCASE, BUS, BUTTON, CAR, CARPET, CAKE, CAT, CAKE, CHAIR, CEILING, CHICKEN, CIRCLE, CLOUD, CLOTHES, COOKER, COAT, COW, DAD, DAY, DOG, DOOR, DOWN, STAIRS, EAR, ELEVATOR, ORANGE, FISH, EIGHT, EYE, FACE, FOUR, FIVE, FOOD, FOOT, FIRE, ELEPHANT, FRIDGE, FAMILY, FRUIT, FINGER, GARDEN, GIRL, GRANDMA, GRANDPA, GRAPE, HAND, HAIR, HEAD, HEART, HOME, HOUSE, LEG, JUMP, JACKET, KITCHEN, KID, LAP, LEMON, LOBBY, LION, MANGO, MARY, MOON, MOM, MILK, MOUTH, NAME, NINE, NIGHT, NOSE, ONE, PENCIL, PEAR, PLUM, PORCH, PIE, PIG, ROOM, ROOF, RAIN, SIX, SEVEN, SHOWER, SNOW, SHOULDER, SKIRT, SHORTS, SHOE, SOCKS, SOFA, STORM, SISTER, SCISSORS, STAR, STAIRS, SKY, SUN, SUMMER, SQUARE, STOOL, TABLE, TEETH, TEN, THAT, TOILET, TOY, TREE, TRIANGLE, TWO, THREE, T-SHIRT, TOMATO, UPSTAIRS, VEGETABLES, WALL, WATER, WHO, WITCH, FISH, WINDOW, WIND

PRONOUN—Pn—U

I, YOU, SHE, HE, IT, WE, THEY, ME, HER, HIM, US, THEM

VERB—V

AM, ARE, ASK, CALL, CARRY, CRY, CUT, DRINK, LOOK, SEE, WANT, GO, COME, GET, PUT, TAKE, DO, KISS, RUN, SING, POINT, LOVE, EMBRACE, LIKE, TOUCH, GIVE, IS, BRING, SAY, SHOW, SPEAK, SIT, SLEEP, WALK, HAVE, EAT, OPEN, CLOSE, HOLD, TURN, MOVE, LAUGH, SMILE, LISTEN, SHOUT, DANCE, JUMP, SHUT, OPEN, FLY, SAIL, DRIVE, RIDE, MISS, TURN, PLAY, ROLL, WAVE, BEEP, RING, HUG, SWIM, SWING, MOVE, KICK, WHISPER, LISTEN, WASH, BARK, WAIT, HIDE, SEEK, FALL, TALK, STOP, START, WORRY, NEED, FREE, CLIMB, STEP, RUN, PICK, BEAT

ADJECTIVE—J

BIG, SMALL, GOOD, BAD, BRIGHT, SWEET, LONG, SHORT, HIGH, LOW, HOT, COLD, COOL, YOUNG, OLD, FAST, SLOW, UGLY, BEAUTIFUL, PRETTY, SOFT, WARM, LOUD, QUIET, RED, YELLOW, BLUE, BROWN, GREEN, HAPPY, SAD, ANGRY, TIRED, SUNNY, WINDY, CLOUDY, HUNGRY, LITTLE, OLD, NEW, TEDDY, FREE, STRONG, TINY, WHOLE, DARK, TALL

ADVERB—R

SLOWLY, QUICKLY, LOUDLY, QUIETLY, SOFTLY, WARMLY, BADLY, NICELY

CONJUNCTION—C

AND, OR, BUT, SO, THEN, THEREFORE, EITHER . . . OR, NEITHER . . . NOR

PREPOSITION—P

ABOVE, IN, ON, BESIDE, BETWEEN, BELOW, BEHIND, UNDER, UP, DOWN, OFF, OVER, OUT, BY, AT, FOR, AROUND, BEFORE, BEYOND, INTO, WITH, WITHOUT, UNDERNEATH, THROUGH, OPPOSITE

### Example 5

The implementation of processing lexical strings in a word-by-word manner to identify relevant argument configurations was achieved by identification of three argument configurations underlying this method, and subsequently developing syntactic and semantic interface analysis. E is entity, R is relation. Es and Rs are identified for the purposes of demonstration as syntactic categories N and V.

One-argument ER Mary_{—N//E} cries_{—V/R}

Two-argument E1 R E2 Mary_{—N//E} likes_{—V/R} John_{—N//E}

Three-argument E1 R1 E2 (R2) E3 Mary_{N//E} gives_{—V//R} John_{—N//E} an apple_{N//E}

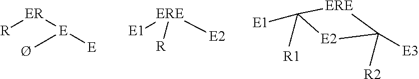

The recursively applied rule adjoins each new element to the one that has a higher ranking in a bottom-up manner, starting with the term that is ‘Ø-merged first’. Conventions are as follows: α₁ is entity/term, α₂ and α₃ are singleton sets, β and γ are nonempty (non-singleton) sets.

A. The term α₁ can be Ø-merged ad infinitum. The function returns the same term as its input. The result is zero-branching structures.

B. Ø-merged α₁ is type-shifted to α₂ and N-merged with α₃. The result is a single argument position of intransitive (unergative and unaccusative) verbs, e.g. ‘Eve₁ laughs’, ‘The cup₁ broke’.

C. Terms α₂ and α₃ are in 2 positions where each can be merged with a non-empty entity.

D. Three positions accommodate term 1 (i, ii, and iii). In double object constructions the number of arguments is limited to three (‘Eve₁ gave Adam₂ an apple₃’).

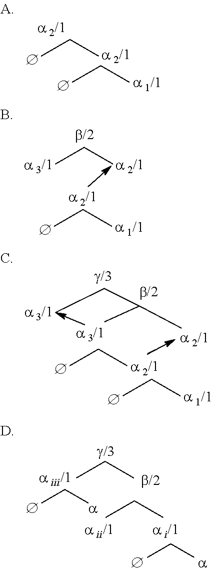

The term A underwent Ø-Merge either first or second. As shown in the Japanese text below, the argument position of ‘the girl’ is ‘Ø-merged second’ in the matrix clause as an object, and ‘Ø-merged first’ in the subordinate clause as a subject.

Yoko-ga kodomo-o koosaten-de mikaketa onnanoko-ni koe-o kaketa Yoko child intersection saw girl called ‘Yoko called the girl who saw the child at the intersection’

### Example 6

The implementation of processing lexical strings in a word-by-word manner to identify relevant argument configurations was achieved by identification of three argument configurations according to the method described herein, and subsequently developing syntactic and semantic interface analysis. E is entity, R is relation. Es and Rs are identified for the purposes of demonstration as syntactic categories N and V.

One-argument ER NP_{—N//E} VP_{—V/R}

[symbol]

Two-argument E1 R E2 NP1_{—N//E} VP_{—V/R} NP2_{—N//E}

[symbol]

Three-argument E1 R1 E2 (R2) E3 NP1_{N//E} VP_{—V//R} NP2_{—U//E} NP3_{N//E}

[symbol]

### Example 7

The implementation of processing lexical strings in a word-by-word manner to identify relevant argument configurations was achieved by identification of three argument configurations according to the method described herein, and subsequently developing syntactic and semantic interface analysis. E is entity and R is relation. Es and Rs are identified for the purposes of demonstration as syntactic categories N and V.

One-argument ER

NP_{—N//E} VP_{—V/R}

One-argument Representation Arabic (Standard):

[symbol]

Two-argument E1 R E2

NP1_{N//E} VP_{—V/R} NP2_{—N//E}

Two-argument Representation Arabic (Standard):

[symbol]

Three-argument E1 R1 E2 (R2) E3

NP1_{N//E} VP_{—V//R} NP2_{—U//E} NP3_{N//E}

Three-argument Representation Arabic (Standard):

[symbol]

### Example 8

The following visual ASL input text was processed in accordance with the steps shown in as described above by means of the input devices for receiving the linguistic input shown in FIG. 15. As mentioned above, words were given a part of speech POS tag and a sentence structure SST tag.

Visual Input:

SST Output: (O)SV(−)(O)SV(−)SV(O)S(−)(−)

POS Output: (N)NV(−)(N)NV(−)NV(N)S(−)(−)

Sentence Boundaries: (O)SV(−)/(O)SV(−)/SV/(O)S(−)(−)

ACM Processed SST Output: SVO/SVO/SV/SVO

Semantic Web Processed Output:

(The) children like apples. (The) girls brought cereal. (The) boys are sleeping. (The) children are watching TV.

### Example 9

Using the method of the present invention, as broadly illustrated in FIG. 7, the following sentences were subjected to POS and SST tagging and the boundaries of the sentences identified.

A. Parsing a string of words ‘(A) big cat look(s) (at) (a) small dog and (a) small dog like(s) (a) big cat (a) small dog run(s) fast I give (a) small dog water’

B. POS Tagging JNVJNCJNVJNJNVJUVJNN

C. SST Tagging SVOSVOSVSVOO

D. Sentence boundaries identification: SVO-C-SVO/SV/SVOO

Parsed Output (A) big cat look(s) (at) (a) small dog and (a) small dog like(s) (a) big cat. Then (a) small dog run(s) fast. I give (a) small dog water.

The following input text was processed in accordance with the steps shown in FIG. 7.

A. Input English ‘mom comes dad comes mom sees dad mom wants milk I give mom milk mom drinks mom catches (a) cat’

B. POS Tagging NVNVNVNNVNUVNNNVNVN

C. SST Tagging SVSVSVOSVOUVOOSVSVO

D. Boundaries POS NV/NV/NVN/NVN/UVNN/NV/NVN

E. Boundaries SST SV/SV/SVO/SVO/UVOO/SV/SVO

F. Parsed Output Mom comes. Dad comes. Mom sees dad. Mom wants milk. I give mom milk. Mom drinks. Mom catches (a) cat.

Applying the steps of the method described above, a plurality of Chinese words can be converted into one or more meaningful sentences and translated into English.

A. Input Chinese (Simple)

[symbol]

B. POS Tagging NVUNUVJN

C. SST Tagging SVOOSVO

D. Boundaries Identification: NVUN/UVJN SVOO/SVO

E. Output (English) Dad gives me a cat. I want a small dog. Mom calls me.

Applying the steps of the method shown in described above, a plurality of Chinese words can be converted into one or more meaningful sentences and translated into English.

A. Input Chinese (Simple)

[symbol]

B. POS Tagging NVUNVNVN

C. SST Tagging SVOSVSVO

D. Boundaries Identification: NVU/NV/NVN SVO/SV/SVO

E. Output (English) The cat runs. The dog wants water.

### Example 10

Applying the steps of the method shown in FIG. 7, a plurality of Spanish words can be converted into one or more meaningful sentences.

A. Input Spanish ‘la niña mira al muchacho el niño tiene un gato el niño da el gato a la niña el gato salta el gato atrapa un ration’

B. POS Tagging ATNVATNATNVATNVNNVNUVNNNVNVN

C. SST Tagging SVSVSVOSVOUVOOSVSVO

D. Boundaries Identification: SVO/SVO/SVOO/SV/SVO

ATNVATN/ATNVATN/ATNVATNPATN/ATNV/ATNVATN

Output Spanish: La niña mira al muchacho. El niño tiene un gato. El niño da el gato a la niña. El gato salta. El gato atrapa un ratón.

Output English The girl looks at the boy. The boy holds a cat. The boy gives the cat to the girl. The cat jumps. The cat catches a mouse.

### Example 11

Applying the steps of the method described above, a plurality of Chinese (Simple) converted to PinYin words was converted into two meaningful sentences.

Input Chinese (Simple)

[symbol]

POS Tagging:

NVUNV

SST Tagging:

SVOSV

Sentence Boundaries Identification:

SVO/SV

Parsed Output Chinese (Simple):

[symbol]

### Example 12

Applying the steps of the method described above, a plurality of Arabic (Standard) words can be converted into one or more meaningful sentences.

Input Arabic (Standard):

[symbol]

[symbol]

POS Tagging: NVUNUVJNNVU

SST Tagging: SVOOSVOSVO

Sentence Boundaries Identification: SVOO/SVO

Parsed Output Arabic (Standard):

[symbol]

[symbol]

As mentioned above, words were given a part of speech POS tag and a sentence structure SST tag.

### Example 13

The following input text was processed in accordance with the steps broadly defined above by means of the input devices for receiving the linguistic input.

S/WL Input: I have a big cat. Dad has a dog. Mom sleeps.

SST Output Sentence Boundary Identification: SVO/SVO/SV

POS Processing for ASL: (O)SV(−)/(O)SV(−)/SV

Processed ASL Visual Output:

### Example 14

The following input text was processed in accordance with the steps described above.

A. Input English ‘mom knows who wants milk dad knows who sees mom she knows who give(s) dad milk mom knows who catches (a) cat’

B. POS Tagging NVNVNNVNVNUNVNNVJNNVNVJN

C. SST Tagging SVSVOSVSVOSSVOOVOSVSVO

D. Main Clause/Subordinate Clause Boundaries Identification: NV[NVN]/NV[NVN]/U[NVNN]VN/NV[NVN]SV[SVO]/SV[SVO]/S[SVOO]VO/SV[SVO]

E. Output Mom knows who wants milk. Dad knows who sees mom. She knows who give(s) dad milk. Mom knows who catches (a) cat.

Applying the steps of the method described above, a plurality of Chinese (Simple) words converted to PinYin was converted into one or more meaningful sentences and further translated into English.

Input Chinese (Simple):

[symbol]

[symbol]

POS Tagging:

NVUNUVJNNVU

SST Tagging:

SVOOSVOSVO

Sentence Boundaries Identification:

SVOO/SVO

Parsed Output Chinese (Simple)

[symbol]

[symbol]

[symbol]

Parsed Output (English):

Dad gives me a cat. I want a small dog (puppy). Mom calls me.

### Example 15

Applying the steps of the method described above, a plurality of Arabic (Standard) words is converted into one or more meaningful sentences.

Input Arabic (Standard):

[symbol]

[symbol]

[symbol]

POS Tagging: NVUANUVAJNNVUANVANVN

SST Tagging: SVOOSVOSVOSVSVO

Sentence Boundaries Identification: SVOO/SVO/SVO/SV/SVO

Parsed Output Sentence Boundaries Arabic (Standard):

[symbol]

[symbol]

[symbol]

### Example 16

The implementation of processing lexical strings in a word-by-word manner to identify relevant argument configurations was achieved by identification of three argument configurations underlying the method of the present invention, and subsequently developing syntactic and semantic interface analysis. E is entity and R is relation. Es and Rs are identified for the purposes of demonstration as syntactic categories N and V.

One-argument ER Mom_{—N//E} cries_{—V/R}

Two-argument E1 R E2 Mom_{—N//E} loves_{—V//R} dad_N//E

Three-argument E1 R1 E2 (R2) E3 Mom_{N//E} gives_{—V//R} dad_{—N//E} an apple_{N//E}

### Example 17

The following input text was processed in accordance with the steps described above.

A. Input English ‘dad sees mom dad_mom milk mom drinks milk dad knows who wants_’

B. Configurations ER2E_EEER2EER1ER2

C. Boundaries ER2/E_EE/ER2E/ER1ER2_/

D. SST Gap Filling Rules SVO/S_OO/SVO/SV/SV_{—}

SVO/SVOO/SVO/SV/SVO

E. Gap Filling by High Count V ‘gives’, O ‘milk’

F. Output Dad sees mom. Dad gives mom milk. Mom drinks milk. Dad knows who wants milk. The following text was processed applying the steps of the method described above.

A. Input English sentences ‘A big black cat eats meat and fish in the kitchen’. A small white dog eats meat in the kitchen. The dog sleeps in the garden.’

B. POS Tagging AJJNVNCNPAN/AJJNVNPAN/ANVPAN

C. SST Tagging SVO/SVO/SV

D. Group Annotation, SST and POS Count SVO AJJNVNCNPAN/SVO AJJNVN PAN/SV ANVPAN

E. High Count ‘a cat’, ‘a dog’, ‘meat’, ‘in the kitchen’.

F. Summary: “A big black cat and a small white dog eat meat in the kitchen’.

The following text was processed applying the steps of the method described above.

A. Input a string of words ‘mom comes dad comes mom sees dad mom wants milk I give mom milk mom drinks milk’

B. POS Tagging, SST Tagging, Sentence Boundaries mom comes/dad comes/mom sees dad/mom wants milk/I give mom milk/mom drinks milk S V S V SVO SVO SVOO SVO

D. Group Annotation Subject—NG: mom, dad, mom, mom, I, mom, mom/VG: comes, comes, sees, wants, give, drinks/Object—NG: dad, milk, milk, milk

E. Frequency Subject-Noun ‘mom’ (4)/Verb ‘comes’ (2)?Object-Noun ‘milk’(3)

F. Summary ‘mom drinks milk’.

### Example 18

Applying the steps of the method described above, a plurality of Chinese (Simple) converted to PinYin words is converted into one or more meaningful sentences and further translated into English.

Input Chinese (Simple):

[symbol]

[symbol]

[symbol]

POS Tagging:

NVUANUVAJNNVUANVANVN

SST Tagging:

SVOOSVOSVOSVSVO

Sentence Boundaries Identification:

SVOO/SVO/SVO/SV/SVO

Parsed Output Chinese (Simple):

[symbol]

[symbol]

Parsed Output (English):

Dad gives me a cat. I want a small dog. Mom calls me. The cat runs. The dog wants water.

### Example 19

The following input text was processed in accordance with the steps described above to obtain sentence boundaries.

Lexical Input Chinese (Simple):

[symbol]

[symbol]

[symbol]

[symbol]

[symbol]

Parsed Output Chinese (Simple):

[symbol]

[symbol]

[symbol]

[symbol]

### Example 20

The following input—Chinese (Simple) converted to PinYin complex sentences—was processed in accordance with the steps described above.

Lexical Input Chinese (Simple):

[symbol]

[symbol]

[symbol]

[symbol]

POS Tagging NVNVNNVNVNUNVNNVJNNVNVJN

SST Tagging SVSVOSVSVOSSVOOVOSVSVO

Main Clause/Subordinate Clause Boundaries Identification: NV[NVN]/NV[NVN]/U[NVNN]VN/NV[NVN]SV[SVO]/SV[SVO]/S[SVOO]VO/SV[SVO]

Parsed Output Chinese (Simple):

[symbol]

[symbol]

[symbol]

[symbol]

Parsed Output (English):

Mom knows who wants milk. Dad knows who sees mom. She knows who give(s) dad milk. Mom knows who catches (a) cat.

### Example 21

The following text was processed and summary obtained applying the steps of the method described above.

Lexical Input Chinese (Simple):

[symbol]

[symbol]

POS Tagging NVUNNVUNNVNVUVNUVN

SST Tagging SVOOSVOOSVSVSVOSVO

SST Tagging SVOO/SVOO/SV/SV/SVO/SVO

Group Annotation, SST and POS Count SVOO/SVOO SVO/SVO SV/SV

High Count:

[symbol]

Summary Chinese (Simple):

[symbol]

### Example 22

The following text was processed and summary obtained applying the steps of the method described above.

Lexical Input Chinese (Simple):

[symbol]

[symbol]

Summary Chinese (Simple):

[symbol]

### Example 23

The following text was processed and summary obtained applying the steps of the method described above.

Lexical Input Chinese (Simple):

[symbol]

[symbol]

[symbol]

Summary Chinese (Simple):

[symbol]

### Example 24

The following text was processed and summary obtained applying the steps of the method described above.

Lexical Input Chinese (Simple):

[symbol]

[symbol]

Summary Chinese (Simple):

[symbol]

### Example 25

The following text was processed and summary obtained applying the steps of the method described above.

Lexical Input Chinese (Simple):

[symbol]

[symbol]

Summary Chinese (Simple):

### Example 26

[symbol]

The following text was processed and summary obtained applying the steps of the method as described above.

Lexical Input Chinese (Simple):

[symbol]

[symbol]

[symbol]

Summary Chinese (Simple):

[symbol]

### Example 27

The following text was processed and summary obtained applying the steps of the method as described above.

Lexical Input Chinese (Simple):

[symbol]

[symbol]

Summary Chinese (Simple):

[symbol]

### Example 28

The following text was processed and summary obtained applying the steps of the method as described above.

Lexical Input Chinese (Simple):

[symbol]

[symbol]

[symbol]

Summary Chinese (Simple):

[symbol]

### Example 29

The following text was processed and summary obtained applying the steps of the method as described above.

Lexical Input Chinese (Simple):

[symbol]

[symbol]

[symbol]

Summary Chinese (Simple):

[symbol]

The method was used for word prediction. The following input text was processed and gaps filled in accordance with the steps described above.

Lexical Input Chinese (Simple):

[symbol] _ [symbol] _

[symbol]

POS Tagging:

NVUUVJNNVNVNVN

SST Tagging:

SVOSVOSVSVSVO

Gap Identification in ACM Configurations:

ER3E_ER2EER2_ER1ER2E

[symbol] _ [symbol] _

[symbol]

Boundaries Identification:

ER3E_/ER2E/ER2_/ER1/ER2E

[symbol] _ [symbol] _

[symbol]

SST Gap Filling Rules:

SVO_/SVO/SV_/SV/SVO

POS Gap Filling Rules:

NVU_/UVJN/NV_/NV/NVN

Gap Filling by High Count:

[symbol] _

[symbol]

[symbol] _

[symbol]

Parsed Output Chinese (Simple):

[symbol]

[symbol]

[symbol]

### Example 30

The following input—Arabic (Standard) complex sentences—was processed in accordance with the steps described above.

Input Lexical String Arabic (Standard):

[symbol]

[symbol]

[symbol]

POS Tagging: UVNVNNVNVNNVNVNNVNVUN

SST Tagging: SVSVOSVSVOSVSVOSVSVOO

Main Clause/Subordinate Clause Boundaries Identification: UV[NVN]/NV[NVN]/NV [NVN]/NV/[NVN]NV[NVUN]; SV[SVO]/SV[SVO]/SV[SVO]/SV [SVOO]O

Parsed Output Arabic (Standard)

[symbol]

[symbol]

[symbol]

### Example 31

The model (ACM) was tested for word prediction. The following input text was processed and lexical gaps filled in accordance with the steps described above.

Lexical Input Arabic (Standard):

[symbol]

[symbol]

[symbol]

[symbol]

POS Tagging:

UVNNVUANANVANVNNVNNVUNANVNUVNVANNVNNVU

SST Tagging: SVOSVOOSVSVOSVOSVOOSVOSVOSVOSVOSVOO

Gap Identification in ACM Configurations:

ER2EER3EEER1ER2EER2EER3EEER2EER2_ER2EER2EER3E_{—}

SST Boundary Identification:

SVO/SVOO/SV/SVO/SVO/SVOO/SVO/SV_/SVO/SVO/SVO_/

Group Annotation, SST and POS Count:

SVOO/SVOO/SVOO; SVO/SVO/SVO/SVO/SVO/SVO/SVO; SV/

High Count:

[symbol]

Gap Filling by High Count:

[symbol] /3; [symbol] /2; [symbol] /1

Semantic Web Evaluation Output:

[symbol]

Parsed Output Arabic (Standard):

[symbol]

[symbol]

[symbol]

[symbol]

### Example 32

The model (ACM) was tested for word prediction. The following input text was processed and gaps filled in accordance with the steps described above.

Lexical Input Arabic (Standard):

[symbol]

[symbol]

[symbol]

POS Tagging: NVUNUVANNVUANVUVUNVUNUVN

SST Tagging: SVOOSVOSVOSVSVSVOOSVOOSVO

Gap Identification in ACM Configurations:

ER3 EEER2EER2EER1 ER2_ER3EEER3EEER2E

Gap Identified in Arabic (Standard) input lexical string:

[symbol]

[symbol]

[symbol]

[symbol]

Sentence Boundaries Identification in ACM:

ER3 EE/ER2E/ER2E/ER1/ER2_/ER3 EE/ER3 EE/ER2E

Sentence Boundaries Identified in Arabic (Standard) input lexical string:

[symbol] [symbol] . . .

[symbol]

[symbol]

SST Gap Filling Rules: SVOO/SVO/SVO/SV/SV(O)/SVOO/SVOO/SVO

POS Gap Filling Rules: NVUN/UVAN/NVU/ANV/UV(N/U)/UNVUN/UVN

Gap Filling by High Count:

[symbol] /2; [symbol] /2; [symbol] /1

[symbol]

Semantic Web Evaluation Output Arabic (Standard):

[symbol]

Parsed Output Arabic (Standard):

[symbol]

[symbol]

[symbol]

### Example 33

A sample text written in the French language was inputted into various online translators and the results are shown below.

Text Input:

Haïti crie famine. Dans ce pays où plus de la moitié de la population a moins de 15 ans, la flambée du cours des céréales oblige 6 habitants sur 10 à se nourrir de boue, un mélange d'argile et d'eau croupie, <<cuisinée>> sous la forme de gâteaux. La crise alimentaire est telle dans cette île de la mer des Caraïbes que c'est le seul repas que peuvent se procurer des milliers de Haïtiens depuis quelques semaines. Les Haïtiens ont toujours mangé de la boue, une habitude locale pour l'apport en calcium. Mais dans cette proportion, les galettes, pleines de microbes, sont très nocives pour la santé.

Online Translation Output 1

Haiti shouts famine. In this country where more half of the population has less than 15 years, the blaze of the course of cereals obliges 6 inhabitants out of 10 to nourish mud, a mixture of clay and stagnated water, “cooked” in the form of cakes. The food crisis is such in this island of the Caribbean Sea that it is the only meal which have been able to get of the thousands of Haitians for a few weeks. The Haitians always ate mud, a local practice for the calcium contribution. But in this proportion, the wafers, full with microbes, are very harmful for health.

Online Translation Output 2

Haiti shouted famine. In a country where more than half the population is under age 15, the soaring grain prices forcing 6 out of 10 to eat mud, a mixture of clay and dirty water, “cooked” in the shaped cakes. The food crisis is such that island in the Caribbean Sea that it is the only meal that can get thousands of Haitians over the past few weeks. Haitians have always eaten mud, a local custom for calcium intake. But in that proportion, patties, full of microbes, are very harmful to health.

Online Translation Output 3

Haiti shouts famine. In this country where more half of the population has less than 15 years, the blaze of the course of cereals obliges 6 inhabitants out of 10 to nourish mud, a mixture of clay and stagnated water, “cooked” in the form of cakes. The food crisis is such in this island of the Caribbean Sea that it is the only meal which have been able to get of the thousands of Haitians for a few weeks. The Haitians always ate mud, a local practice for the calcium contribution. But in this proportion, the wafers, full with microbes, are very harmful for health.

Online Translation Output 4

Haiti shouts famine. In this country where more half of the population has less than 15 years, the blaze of the course of cereals obliges 6 inhabitants out of 10 to nourish mud, a mixture of clay and stagnated water, “cooked” in the form of cakes. The food crisis is such in this island of the Caribbean Sea that it is the only meal which have been able to get of the thousands of Haitians for a few weeks. The Haitians always ate mud, a local practice for the calcium contribution. But in this proportion, the wafers, full with microbes, are very harmful for health.

Each of these translations resulted in errors to the context and meaning of the original text. The same input text was submitted to an electronic translator operating under the rules and steps of the present invention as described herein. The output was as follows:

Output from translator executing the method defined herein:

Haiti cries famine. In a country where more than half the population is under age 15, the soaring grain prices force 6 out of 10 to eat mud, a mixture of clay and dirty water, “cooked” in the shape of cakes. The food crisis is such on this island in the Caribbean Sea that thousands of Haitians could get only this meal over the past few weeks. Haitians always ate mud, a local custom for calcium intake. But in that proportion, patties, full of microbes, are very harmful to health.

### Example 34

A sample text written in Chinese (Simple) was inputted into various online translators and the results are shown below.

Text Input Chinese (Simple):

[symbol]

[symbol]

Online Translation Output 1

Dad gave me the cat I want to call me mother puppy dogs to cats to run water

Online Translation Output 2

The cat I Dad gave me want to call me mother puppy dogs to cats to run water

Online Translation Output 3

The father gives me the cat I to want the puppy mother to call me the cat cat to race dogs wants the water

Each of these translations resulted in errors to the context and meaning of the original text. The same input text was submitted to an electronic translator operating under the rules and steps of the present invention. The output was as follows:

Output from translator executing the method defined herein:

Dad gives me a cat. I want a small dog. Mom calls me. The cat runs. The dog wants water.

### Example 35

A sample text written in Arabic (Standard) was inputted into various online translators and the results are shown below.

Text Input Arabic (Standard):

[symbol]

[symbol]

Online Translation Output 1

Abi gives me a small dog CAT I want my mother invites me dog wants water

Online Translation Output 2

Fathers gives me the cat wanted small dog illiterate calls for me the dog the water wants

Each of these translations resulted in errors to the context and meaning of the original text. The same input text was submitted to an electronic translator operating under the rules and steps of the present invention. The output was as follows:

Output from translator executing the method defined herein:

[symbol]

[symbol]

English (Standard) Output from Natural Language Processor according to the present method:

Dad gives me a cat. I want a puppy. Mom calls me. The dog wants water.

### Example 36

A sample S/WL text was inputted into various online translators and the results are shown below.

S/WL Input: I have a big cat dad has a dog mom sleeps

Online Translation Spelling ASL Output:

Visual ASL Output from method described herein:

Sentence 1:

Sentence 2:

Sentence 3:

1. A method for converting a plurality of words into one or more sentences, comprising the steps of:
obtaining a plurality of words;
assigning a part of speech tag to each of said words;
assigning a sentence structure tag to said plurality of words; and
parsing said words into one or more sentences based on a predefined sentence structure.

2. The method of claim 1, wherein said part of speech tag is selected from noun, verb, adverb, adjective, conjunction and preposition.

3. The method of claim 1, wherein said sentence structure tag is selected from noun verb, subject verb object, subject verb object, subject verb object object, subject object verb, verb subject object, object subject verb, verb subject object and object verb subject.

4. The method of claim 1, further comprising applying a set of rules to boundary absent word strings prior to parsing said words into one or more sentences.

5. The method of claim 1, further comprising applying a set of rules to said one or more sentences to confirm conformity with syntactic and semantic parameters.

6. The method of claim 1, further comprising identifying relevant argument configurations based on the part of speech tagged words prior to assigning sentence structure tags to the plurality of words.

7. The method of claim 6, wherein the argument configurations are entity relation, entity relation entity and entity relation entity (relation) entity.

8. The method of claim 6, wherein the argument configurations generate strings of words that are compared against the sentence structure tags to identify legitimate and illegitimate strings of words.

9. The method of claim 1, wherein the predefined sentence structure is selected from any one of Tables 1 to 4.

10. The method of claim 1, wherein the predefined sentence structure is selected from Table 5 or 6.

11. The method of claim 6, wherein the step of identifying relevant argument configurations comprises assigning an embedded clause tag to the words.

12. The method of claim 1, wherein the plurality of words are from the English language.

13. The method of claim 1, wherein the plurality of words are from the Chinese language.

14. The method of claim 1, wherein the plurality of words are from the Arabic language.

15. The method of claim 13, further comprising converting the plurality of words into PinYin words prior to assigning the part of speech tag to each of said words.

16. The method of claim 1, wherein the plurality of words are gestures from American Sign Language.

17. A computer implemented method for converting a plurality of words into one or more sentences, comprising the steps of:
obtaining a plurality of words;
assigning a part of speech tag to each of said words;
assigning a sentence structure tag to said plurality of words; and
parsing said words into one or more sentences based on a predefined sentence structure.

18. A computer program product comprising a computer readable memory storing computer executable instructions thereon that when executed by a computer perform the method steps of claim 1.
